(19) United States
(12) Patent Application Publication
(10) Pub. No.: US 2002/0087496 A1
(43) Pub. Date: Jul. 4, 2002

(54) System, method and applications for knowledge commerce

(76) Inventors: Paul A. Stirpe, Shoreham, NY (US); Subhra Bose, Manorville, NY (US)

Correspondence Address: Thomas A. O'Rourke, Wyatt, Gerber & O'Rourke, L.L.P., 99 Park Avenue, New York, NY, 10016, US

(21) Appl. No.: 09/826,410

(22) Filed: Apr. 4, 2001

Related U.S. Application Data
(60) Provisional application No. 60/194,737, filed on Apr. 5, 2000.

(51) Int. Cl. G06F 17/00

(52) U.S. Cl. 706/45

(57) ABSTRACT

A knowledge commerce system is disclosed. The system includes a knowledge exchange system, a knowledge recipient, and a knowledge expert. The system further includes a communication medium. The knowledge exchange system includes one or more data stores containing knowledge components, a commerce engine, a knowledge delivery system and a security system.

Priority is based on U.S. Provisional Application Ser. No. 60/194,737 filed on Apr. 5^{th}, 2000, the disclosures of which are incorporated herein by reference.

### BACKGROUND OF THE INVENTION

1. Technical Field

The invention describes a system, method and applications that incorporate the buying and selling of expertise using a knowledge exchange system among one or more parties coupled with a delivery system for providing a mechanism for knowledge exchange. Those that have knowledge (experts or content authors) may make knowledge available for sale by setting a price and other characteristics of the knowledge component in the knowledge exchange system. The knowledge component is a collection of some body of knowledge. Those that desire to obtain knowledge (recipients) may locate knowledge components of various kinds within the knowledge exchange system, comparatively shop based on price or other factors, enroll to become a recipient of the knowledge, and obtain the knowledge via the knowledge delivery system. Experts may deliver knowledge to the recipients via the knowledge delivery system. The knowledge delivery may be accomplished using live, archived and self-paced sessions. Sessions may utilize various collaboration tools to provide interactive and multimedia enabled knowledge delivery.

One or more institutions (companies, universities, consulting agencies, etc.) may have knowledge components of various types to offer to recipients. The invention further describes a system whereby institutions may automatically provide knowledge components and their characteristics, such as the dates and times that the knowledge component may be offered, the knowledge component price, to the knowledge exchange system. The automation of the interaction between the institutions and the knowledge exchange system improves the breadth and accuracy of the knowledge components offered by the knowledge exchange system, as well as the efficiency by which large numbers of knowledge components may by be found, purchased and delivered. Several applications of the knowledge commerce system are described including E-learning services, live conference services, consulting services, kiosk presentation services, live streaming services, and collaborative web casts.

2. Related Information

There is a huge body of knowledge held by people or experts with specific skills. Traditionally, to acquire specific knowledge, one must attend an institution of higher learning, or attend a seminar or conference. In short, one usually must go to a physical place that offers that specific expertise, in order to obtain the knowledge. Alternatively, knowledge is contained in books or literature. However, it is often more time consuming to obtain knowledge from the written word because the knowledge delivery is provided only by written text. Knowledge can potentially be delivered more efficiently if a live trainer is included in the delivery, or if there is collaboration with other recipients, or if the delivery utilizes many kinds of medium, e.g. audio, video, graphics, text. Education or the transfer of knowledge usually requires the combination of written information along with other knowledge transfer mechanisms. In short, efficient learning usually requires that the recipients attend a class or seminar and interact directly with the trainer and potentially other recipients.

With the advent of the communication networks, learning may now be carried-out over distances, where the trainer is broadcast to the recipients, the later of which may not be co-located with the trainer nor with each other. This method of knowledge exchange is commonly referred to “distance learning”, Internet based training, and E-learning.

E-learning has been held-back by technology. Only until recently has collaboration technology and the Internet communications infrastructure matured to allow highly collaborative, multimedia enabled e-learning around the world, over the world wide web, breaking down the barriers of distance and time.

The commerce aspects of today's e-learning systems has traditionally been ignored or have been rigid or inefficient, and as such has hampered the creation of large, fluid, rich knowledge exchange marketplaces. Furthermore, technology has limited the ability for collaborative knowledge exchange to take place over distances. This invention includes the specification of a knowledge exchange system that automates the process by which knowledge is contributed to the knowledge exchange system by experts or institutions, is offered for sale, found and paid for, and delivered to recipients. The knowledge exchange system thus facilitates the creation of efficient, fluid, and highly collaborative knowledge exchange marketplaces over the Internet or any communications medium.

In recent years, electronic commerce (E-commerce) web sites have begun to proliferate on the Internet and other medium¹. E-commerce typically allows for the sale and purchase of goods and services. There are three major types of E-commerce capabilities; namely, business-to-consumer, business-to-employee, and business-to-business. Business-to-consumer E-commerce sites typically offer products and/or services to consumers. Consumers usually purchase the product or service over the Internet using a credit card. If the good purchased includes, but is not limited to a physical item, it is then shipped to the consumer. The consumer may have the option of returning the item if the consumer is not satisfied with the item. ¹From herein when we refer to the Internet, we mean the Internet and any other such communications medium, e.g., public or private network.

Business-to-employee E-commerce capabilities typically are oriented towards an institution or business providing services to their employees. For example, a corporation may outsource the knowledge exchange system to knowledge exchange provider, for the purposes of providing e-learning services to their own employees. The corporation may develop and contribute customized content that is to be available only to their employees and not generally available to the public. In this case, the knowledge commerce service provider is providing business to employee services to the corporation. Typically, some degree of co-branding is utilized.

Business-to-business E-commerce capabilities include, but are not limited to commerce between businesses. For example, the Ford Motor Company may utilize business-to-business capabilities to automatically order and pays for parts from one or more parts suppliers. When the parts available at the Ford automobile manufacturing plant become low or below some threshold, Ford may automatically order more parts from their suppliers. The business-to-business interactions are automatic and do not require manual intervention once the relationship has been established between the businesses. This example illustrates the business-to-business model for the commerce of physical commodities, such as auto parts. The business-to-business model may also apply to the exchange of services (non-physical items), such as digital information, e.g., a streaming media file.

The invention includes the description of a more efficient system than exists today, for the commerce of knowledge. The components of the invention includes but not limited to a knowledge exchange system that supports manual and automatic knowledge component contribution to a data store, coupled with a search engine, knowledge delivery system and commerce engine. The knowledge exchange system integrates both a business-to-consumer model and a business-to-business model for the commerce of knowledge. The invention provides for the efficient buying, selling, and delivery of knowledge from experts to recipients located anywhere. The invention provides for a more efficient system for knowledge commerce over the Internet, world wide web or any like medium where the participants may be remotely located with respect to each other. The present invention has applicability to public and private networks of all types including but not limited to the world wide web, the Internet, mobile and satellite networks, all private networks including but not limited to private corporate networks, private virtual networks, and home based networks.

### SUMMARY OF THE INVENTION

The invention describes a system, method and applications whereby efficient knowledge commerce may take place over the Internet or any like medium. FIG. 1 illustrates a basic knowledge commerce system. The knowledge commerce system includes, but is not limited to one or more knowledge exchange systems (100), one or more knowledge recipients (106), one or more knowledge experts (107), zero or more institutions (108), zero or more trainers (111) all of which may or may not be remotely located with respect to each other over a communications medium (105). Experts, trainers, recipients, institutions and institutional administrators are considered users of the system. The knowledge exchange system is typically operated by a knowledge exchange service provider that may subsequently have one or more administrators and operators. The invention combines a knowledge exchange system with the business-to-business, business-to-employee, and consumer-to-business commerce models.

The knowledge exchange system includes, but is not limited to one or more data stores (115) containing knowledge components and their characteristics (e.g., price, scheduled offering dates and times), a commerce system (103), a knowledge delivery system (101), and a security system (112). The knowledge exchange system may also include but is not limited to one or more a search engines (104), personalization engines (117), content management system (119), content index systems (116), invitation management systems (101), calendar systems (113), and rating systems (118). The search engine (104) aids recipients to locate knowledge with which they may have interest. An example of a search engine is www.google.com, where users type in a keyword and the system locates information related to that keyword. The personalization engine (117) may provide end users with a personalized view of the system. The content management system provides support for syndication of content, help to experts in publishing knowledge components, as well as other features. A content index system (116) provides a view of the system such that the knowledge components are organized in an ontology. The index system can provide anther way for users to locate knowledge components of interest, by navigating an ontology or a graph that represents the relationships of domain specific concepts (content graph). As users navigate the concept graph, they may be provided with links or referrals to the knowledge components that relate to the concepts.

The invitation management system (114) provides means by which trainers may invite recipients to attend sessions or courses. The trainer may interact with the invitation management system to specify who is to be invited to a presentation, establish automatic reminders for to recipients to be reminded of the date and time, prior to a pending live presentation, as well as provides URLs to recipients that enable them to more quickly and easily gain access to the knowledge component. For example, the trainer may interact with the knowledge commerce system to schedule the date and time that a knowledge component is to be delivered. The invitation management system may then create a URL that may be emailed to the recipients that helps the recipients register with the service, locate the presentation, enroll in the presentation and pay for it if required, and finally attend the presentation.

The calendar system (113) can provide personal and shared calendar capabilities for individual, groups, and anonymous. The calendar system is useful for individuals to schedule the date and times of presentations that they may be delivering or obtaining as a recipient. It is useful for providing anonymous users with the ability to search a calendar of event to determine when particular knowledge components are being provided are available. The calendar system is useful for groups of users or institutional to schedule their private knowledge component offerings, without others outside the institution seeing the schedules of institutional knowledge component delivery. The calendar system can also provide users with the ability to do contact management. This can interoperate with invitation management to allow trainers to identify the recipients to which invitations should be sent. For example, a trainer can input the names and email addresses of potential recipients in his or her personal contact management database. When the trainer is generating invitations to a close group of users, the trainer may select from the database of personal contacts already entered in his or her contact manager database. The contact management capabilities provided by the application Microsoft Outlook is a good example of contact management.

The data store is the repository for the knowledge components. The data store (115) may consist of private areas (114) where only authorized users have access, and public areas (102) where the general public may have access to the knowledge components. For example, the data store may hold a presentation pertaining to a particular course on cave diving. The cave diving course may have the following characteristics.

Price: $99.99, Start Date: Mar. 2, 2000, End Date: May 2, 2000, Meeting Frequency: Monday, Wednesday, Friday, Start Time: 9:30 AM, End Time: 11:00 AM. Course Title: Cave Diving, Course Description: This course provides certification for SCUBA divers desiring to obtain their cave diving license., Offering Institution: PADI.

The knowledge component may have been contributed by anyone, such as an expert, group of experts, or institution. The contributor(s) are authenticated, and authorized by the security system of the knowledge exchange system prior to contributing knowledge components. The knowledge exchange system may make available to potential recipients the characteristics of the knowledge components, so that potential recipients may obtain adequate information to make a purchasing decision and enroll to obtain the knowledge component (business-to-consumer commerce model). The knowledge component characteristics are available for users to locate and view via the search engine. The search engine allows users to locate knowledge components from the data stores. The search engine allows users to specify various criteria to locate knowledge types. For example, a user may desire to locate training courses that are taught live, offered between in the second quarter of 2000 on the subject of cave diving.

The knowledge exchange system may also include content indices that show the hierarchy or ontology of knowledge components available in the data stores. The content indices may provide listings of the knowledge components available in the data store organized by content type, category or other characteristics of the content. The content may be indexed by many criteria and allow users to more quickly find knowledge components of interest. Users may navigate the various content indices to determine what is available within a given content type or category.

The knowledge delivery system provides for the delivery of the knowledge component from one or more experts (or trainers) to one or more recipients. The trainer may not necessarily be the expert, but may simply use the delivery system to delivery the content prepared by the expert. The delivery system allows the expert(s) to be remotely located from each other and the recipients. The recipients may also be remotely located from each other.

The delivery system provides for live, archived and self-paced knowledge component delivery. Live delivery requires that one or more experts provide the delivery at one or more scheduled dates and times. The live delivery, including collaboration or user interactions, may be archived or saved. The archived knowledge component may be purchased and obtained by future recipients after the live delivery has occurred. Self-paced knowledge delivery usually requires that the expert(s) create the knowledge component off-line and then make it available for recipients to obtain. Self-paced knowledge delivery is like that of archived knowledge components, except that the component may have not been offered via live delivery, and the live interactions may not have been captured.

The knowledge delivery system may be comprised of, but is not limited to, one or more components including audio, video streaming of the trainer to the recipients, the ability for recipients to type or speak questions to the trainer, the ability for the trainer to type or speak replies to the questions and deliver replies to one or more recipients, white board, remote program demonstration capabilities, discussion groups, chat and email lists. The knowledge delivery system is comprised of many collaboration tools to aid in the delivery of the knowledge component from the expert(s) to the recipients over the Internet or any like medium. Furthermore, the delivery system may utilize one or more data centers including, but not limited to computers, storage devices, load balancing devices or other devices that support the delivery of the knowledge components over the Internet.

The knowledge delivery system may include a real-time polling system that allows trainers to poll recipients instantly during a training session. That is, the trainer may pose a question that is displayed at the recipient's computer. The recipients may answer the question and the results are aggregated and displayed at the trainer's computer.

The knowledge delivery system also provides a means by which trainers may include quiz questions during a self-pace or archived training session. The system may store the results of the quiz questions for each recipient in a database, and provide automatic grading services to the trainer.

The knowledge delivery system includes a real-time group membership system that provides to the trainer the list of members that are participating in the training. If a member joins or leaves the training session, the trainer may be informed of the change in membership. Furthermore, if one or more users are disconnected from the trainer, the trainer is informed of which users are disconnected. As the connectivity is repaired, the trainer is informed as the recipients re-join the session. The real-time group membership service provides feedback to the trainer and the knowledge exchange service provider (the organization that operates the knowledge commerce system) as to the quality of the service delivery. The group membership information may be stored in a log. If some recipients obtain inadequate service during knowledge delivery, the knowledge exchange service provider may verify the level of service by examining the log, and take appropriate action, such as to compensate the recipient.

The knowledge exchange system may include an Interactive Question and Answer (IQ&A) service that allows remotely located recipients to speak or type questions to the trainer, and for the trainer to speak or type responses to one or more recipients.

The knowledge exchange system may include follow-me browsing capabilities that allow trainers or authors to take recipients on a tour of the Internet or other like systems. That is, the trainer or author may push Internet pages to the recipients during live, self-paced, or archived presentations such that the recipients see the web pages specified by the trainer or author for the duration specified by the trainer or author. Additionally, as the trainer navigates his local view, the recipients may see the same pages as the trainer does, as the trainer navigates. Thus, the recipients may be brought on a tour of the Internet, for example, lead by the trainer. Follow-me browsing may be used in archived or self-paced knowledge components such that the recipient is brought on a tour of the Internet or other like medium. The navigation may be accompanied by but not limited to a streaming audio narration of the tour.

The knowledge exchange system may include an annotation service that allows the trainer or author to annotate web pages during live, self-paced or archived presentations. The annotation service may support the ability for the trainer or trainers to draw on their local computer screens and those drawings, mark-ups or annotations are rendered to one or more recipients. This allows the trainer to highlight portions of the knowledge component, to provide such features as dynamically underlining items, drawing on slides, circling items. The annotation service may provide similar capabilities as the White Board tool, except the annotation service may but is not limited to annotating the web pages that are or have been pushed to the recipients. Thus, the annotation service may be more tightly coupled with the Page Flip service.

The knowledge commerce system allows for remote parties, including users and computers that are not necessarily co-located with the knowledge exchange system, to interact with the knowledge exchange system to provide knowledge for sale (experts and institutions), and receive knowledge for fee (recipients) over the Internet (105) or other communication mediums. Furthermore, the knowledge exchange system provides capabilities for the institutions to automatically provide knowledge components and other characteristics to the knowledge exchange system without human intervention, from herein forward referred to the business-to-business commerce model (b2b). This provides for an efficient mechanism by which institutions may make for sale their knowledge, and for the knowledge exchange system to accurately reflect the knowledge that is available from institutions, along with the respective knowledge component related characteristics. Institutions may have experts as members and thus desire to provide the knowledge held by the institution's experts for sale or simply extend the availability of the knowledge. By automating the interactions between the institution and the knowledge exchange system, the knowledge exchange system provides the most accurate knowledge information to users. Furthermore, this allows the institution to offer their knowledge for sale to recipients anywhere, thus extending the reach of the institution. Users may be members of institutions and may also obtain knowledge from the knowledge exchange system.

The knowledge exchange system includes a commerce engine that can support various billing models. The invention also outlines several billing models that support business-to-business (b2b), business-to-employee (b2e) and business-to-consumer (b2c) models.

In one billing model, institutions or content providers pay a periodic service fee to the knowledge exchange service provider for use of the service. Knowledge component providers are motivated to pay the service fee to extend the reach of the institution and reap the benefit of selling their knowledge components worldwide.

Recipients (consumers) may pay for the knowledge component during the enrollment process. Payment is accepted from recipients via credit card or other electronic payment methods. The knowledge exchange service provider may be the merchant of record and collect all consumer fees on behalf of the knowledge component offering institution. The knowledge exchange service provider may collect a percentage of the consumer payment of the knowledge component offering. Periodically, the knowledge exchange service provider may provide back to the offering institution any surplus in the difference between the institution service fee and the total of all consumer collections made for knowledge components offered on behalf of the institution less any percentage charged by the knowledge exchange service provider to the consumer. If no surplus exists, the institution will be billed for the remaining subscription fee. The actual invoicing or billing of the institution may be carried-out periodically.

Members of the institution may not be required to pay for knowledge components offered by the institution. That is, the institution may offer knowledge components to all its members without requiring the institutional members to pay for the knowledge component offering. All other users (non-members of the institution) would be required to pay for the knowledge component offering. An institution may offer knowledge components to any member for free. Institutions, however, may pay a higher service fee to the knowledge exchange service provider to cover the cost of doing business (loss of consumer revenue). This is an example of a b2e model.

In an alternative billing model, each institution may be assigned the merchant of record for knowledge components offered by the knowledge exchange system on behalf of the institution. In this billing model, the knowledge exchange service provider would charge a periodic service fee to the institution. Users pay for knowledge components offered by the institution via the knowledge exchange system, using their credit card or other electronic forms of payment. The merchant of record for the credit card processing would be the institution and not the knowledge exchange service provider in this alternative billing model. The knowledge exchange service provider would track the usage of the system and charge back to the institution a percentage of the consumer payment for the knowledge component offering. In this alternative billing model, the institutions themselves are held liable for any credit card charge backs that may arise during the operation of the knowledge exchange service.

The knowledge exchange service provider may charge the institutions differing charges based on the level of collaboration contained in the knowledge component offering. For example, knowledge components that require higher bandwidth such as video and audio streaming capabilities may cost the knowledge exchange service provider more to provide. Subsequently, the knowledge exchange service provider may charge higher service charges to offer such knowledge components.

The knowledge exchange system contains a security system that minimally provides authentication of users, and authorization to access knowledge components. Authorization assures that only those users that are privileged to access or change knowledge components are permitted to do so.

The knowledge exchange system may include a knowledge rating system. Recipients of knowledge components are permitted to rate the knowledge components for which they have obtained. Ratings for the knowledge components become available for other users to view and can be used to evaluate the value of the knowledge component. The rating information may be available either explicitly as was contributed by recipients, or aggregated, such as in a scale of 1-10, where 1 is the best and 10 is the worst. Multiple rating criteria may be used and displayed. Users can use the rating information to determine if the knowledge component is of value to purchase. The rating system may be coupled with the search engine results, such that the rating characteristics may be utilized as criteria for searching for knowledge components.

The knowledge exchange system may additionally include a personalization engine that allows users to specify knowledge content types or categories of interest. The knowledge exchange system may inform the users of new knowledge component types that match the types or categories of interest specified by the users, as the new knowledge components become available. Personalization is typically implemented by integrating user registration information maintained in a directory service with user preferences that may be explicitly specified by the user, or captured as user behavior in the form of click stream activities. That is, depending on what types of knowledge components the user has already accessed, the system may provide the user with notification of additional knowledge components of similar concept, as they become available or are available within the knowledge exchange system.

The knowledge exchange system may support closed users groups that allow a trainer or expert to select the users to be invited to the knowledge exchange session. The users may be selected for the list of users that are registered with the knowledge exchange system, and may also include any user that has an email address associated with them. Users may be invited to attend knowledge component sessions via email. The email body may contain reference information to indicate to the user how and when to connect and attend the session. Invitees may or may not be required to register with the knowledge exchange service provider, if the session files are located in a publicly accessible area in the knowledge exchange system. In this case, when the user attempts to attend the session, the knowledge exchange service would simply render the session with the user, and not necessarily require the user to first register with the knowledge exchange service provider, nor require the user to login.

The knowledge exchange system may provide branding of institution based knowledge components, such that users are lead to believe that the knowledge exchange system is part of the branded offering of the institution. This type of branding can be provided by the knowledge exchange system by providing institutional branded icons, and look and feel common to the institution. The knowledge exchange system may also provide co-branded support, such that the knowledge exchange service provider and the institution are both promoted to the users for providing the knowledge components offered by the institution. Finally, the knowledge exchange may provide knowledge components promoted as offered directly by the knowledge exchange service provider itself. For example, the knowledge exchange service provider may provide help desk services as part of the knowledge exchange service. The knowledge exchange service provider may solely brand such services.

In support of branding and co-branding, each institution may be provided with an “institution page” (or one or more web pages) advertising characteristics of the knowledge component's institution. The institution page may be automatically generated and associated with all knowledge components offered by the institution. An institution representative (administrator) may be permitted to edit the institution page to redesign the layout, look and feel and content. Knowledge component search results may include references to the institution page to aid the user in assessing the value of a knowledge component. Recipient rating results of the knowledge components offered in the past by the institution may also be provided on the institution page. For example, all rating for knowledge components offered by the institution may be aggregated and displayed on the institution page. Users may use the rating as an indication of the quality of knowledge components historically offered by institution.

Each knowledge component offering may be provided with a “knowledge component” page (or more web pages) for providing detailed information about the knowledge component, such as the course syllabus, announcements as they come about, news or other information. The expert may author the knowledge component web page and update it as required. The recipients may access the knowledge component page to keep abreast as to the latest information concerning the knowledge component. The knowledge component page may be restricted to only those recipients that have been authorized to participate in the knowledge component offering if the component has restricted access. For example, only those recipients that have paid for or enrolled in a knowledge component offering may be permitted to view the knowledge component page. The knowledge component page may also be considered as a “Collaboration Center”, where users gather on-line to collaborate via text or voice chat, discussion groups, sharing presentations, exchanging email, arrange for group or sub-group meetings, hold phone conversations, or in general share ideas and collaborate together with respect to the knowledge component or a common concept of shared interest amongst the collaborators.

The knowledge exchange system may use the underlying messaging technology for multiple collaboration applications based on the disclosures of a co-pending application entitled “System, Method and Applications for Real-time Messaging over HTTP-based Protocols, filed on Mar. 31, 2000 with Ser. No. 60/193,75” and hereby incorporated herein by reference, and Ser. No. filed on Apr. 2^{nd}, 2001.

Each expert and trainer may be provided with an “expert/trainer page” (one or more web pages) detailing the credentials of the trainer for the knowledge components. Such items as references to the knowledge components developed and offered by the expert or trainer may be listed. Furthermore, knowledge component search results may include references to the expert/trainer page to aid the user in assessing the value of a knowledge component and the credentials of the expert of trainer. Recipient individual and/or aggregated rating results of the knowledge components offered in the past by the expert or trainer may be provided on the expert/trainer page. Potential recipients may use this information to select a preferred knowledge component with which to enroll.

The knowledge exchange system may enforce users to usage policies by prompting users to accept usage policies prior to allowing the users to use certain capabilities of the knowledge exchange system. For example, users that desire to become recipients may first be required to accept a usage policy for recipients, the content of which is determined by the knowledge exchange service provider. Users that desire to become content authors (experts or trainers) are prompted to accept the author's policy prior to first use of the content authoring capabilities.

The knowledge exchange system may support delayed user registration. That is, users may anonymously search for knowledge components using the search engine or content indices as tools. However, prior to being permitted to become a recipient for non-free knowledge components, users may be required to register with the service. Registration typically requires users to provide basic information such as their first, last name, address, and country. Users may be required to register even for access to free knowledge components.

The knowledge exchange system may provide delegated administration such that one or more privileged users or members of an institution are provided with control over most or all of the knowledge components offered by the institution, and the institution membership that uses the knowledge exchange service. For example, an institutional administrator may have the privileges in the knowledge exchange system to alter the schedule of knowledge component offering dates and times, change which trainers deliver knowledge components, check the billing status for all knowledge component offerings made by the institution. The institutional administrator may have the privilege to add institution members as users of the knowledge exchange service.

There are several applications of the invention.

An application of the knowledge commerce invention includes Internet based training or E-Learning. Institutions may but are not required to automatically provide knowledge component characteristics to the knowledge exchange system without requiring human intervention. Training courses or presentation may be provided live, self-paced, or from an archive over the Internet.

Another application of the invention is live conferences. There are thousands of conferences and seminars provided all over the world. The invention would permit conference providers to extend their conferences to the Internet. Conferences can be simultaneously delivered over the Internet and can support collaboration with remote users. Conference providers would obtain additional revenues from remote recipients that attend the conference over the Internet, rather than by physically attending the conference.

Another application of the invention is web based consulting. Consultants would use the knowledge commerce system to provide knowledge exchange to their clients.

Another application is the demonstration, sales and marketing of goods and services over the Internet. The knowledge exchange system may be utilized to demonstrate, sell or market goods and services to remote recipients. For example, a software vender may utilize the knowledge exchange system to demonstrate its software over the Internet to potential customers of the software.

Another application of the invention is the outsourcing of kiosk presentations to the knowledge exchange service provider. In this application, web developers may include kiosk presentations from their web sites. The presentations may actually execute using the knowledge exchange service provider infrastructure, including the knowledge delivery system. The web site developer need not become familiar with the requirements for running multimedia enabled presentations, and can utilize the tools and capabilities provided by the knowledge exchange service provider. Visitors to the developers web site are not necessarily aware that the presentation is being executed from the knowledge exchange service provider, but think the presentation is being driven from the developer's web site. In this mode of operation, the knowledge exchange service provider would not require the user to register prior to viewing the presentation. The author of the presentation would, however, be required to register with the knowledge exchange service provider to contribute, edit, update the presentations and make them available by reference from their web site.

For example, a travel based web site may wish to present a multimedia-enabled presentation on Bermuda. The developer of the web site may contribute the knowledge component to the knowledge exchange system, and place a Universal Resource Locator (URL) on the travel site's page that refers to the Bermuda presentation held at the knowledge exchange. Users of the travel site may view the Bermuda presentation by clicking on a link on the travel web site.

Another application of the invention includes live streaming services. Any user with a camera may use the knowledge exchange system to stream audio and video from anywhere to recipients that pay for access to the stream. The holder of the camera is considered to be the content provider and thus expert. The consumers of the stream are recipients. Again, the streaming capability is out-sourced to the knowledge exchange service provider unbeknownst to the user of the content provider's web site.

Another application of the invention is collaborative web casts. Typically web casts are one way from source to receivers. The knowledge commerce system allows for collaborative web casts to take place, with many features provided by the knowledge delivery service. For example, real-time town meetings are possible where a politician may speak to the audience over the Internet, and the recipients of the talk may collaborate by asking questions via telephone, typing, and email. The speaker may respond using the knowledge delivery system.

The knowledge commerce system may be combined with many other services such as job placement services, consulting location services (e.g. Guru.com), educational certification or degree programs to name a few.

### BRIEF DESCRIPTION OF THE DRAWINGS

In the following text and drawings, wherein similar reference numerals denote similar elements throughout the several views thereof, the present invention is explained with reference to illustrative embodiments.

FIG. 1 shows the components of the knowledge commerce system including, but not limited to the knowledge exchange system, institutions, experts, trainers, recipients and a connection medium.

FIG. 2 shows the components that make up the knowledge delivery system that supports real-time, self-paced and archived knowledge delivery.

FIG. 3 depicts the user registration process with the knowledge exchange system

FIG. 4 shows the process of manual knowledge component contribution to the knowledge exchange system

FIG. 5 illustrates the method of automatic knowledge component contribution to the knowledge exchange system.

FIG. 6 shows the search and enrollment process that users invoke to locate knowledge components of interest and enroll to be delivered the knowledge component

FIG. 7 illustrates the process by which trainers and recipients participate in live knowledge delivery sessions.

FIG. 8 illustrates the billing model for individual expert contributors

FIG. 9 illustrates the pass through billing model

FIG. 10 illustrates an example interaction between institutions and/or experts with the knowledge exchange system for content contribution or adjustment.

FIG. 11 shows an example file system architecture that supports delegated administration for authorization purposes.

FIG. 12 shows an example directory services architecture that supports delegated membership administration.

FIG. 13 shows the billing model characteristics organized by role.

FIG. 14 shows a billing model applicable to institutions

### DETAILED DESCRIPTION OF THE PREFERRED EMBODIMENTS

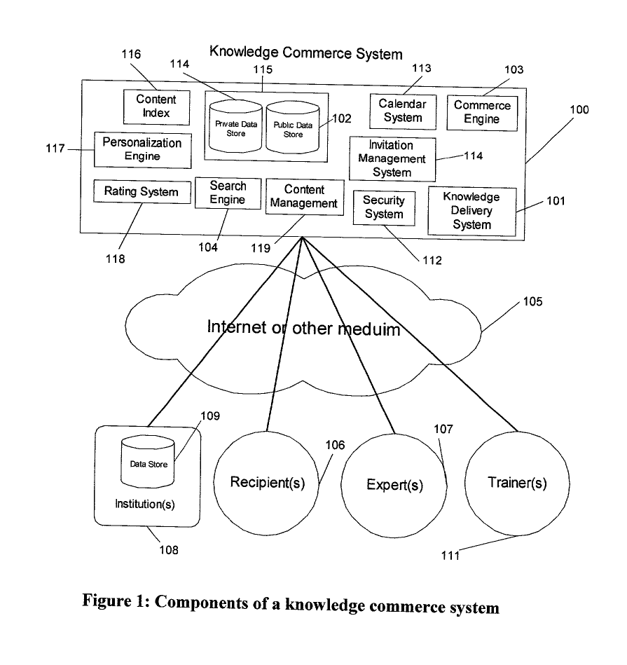

The invention describes a system, method and applications for an electronic based knowledge commerce system. The knowledge commerce system shown in FIG. 1 includes, but is not limited to one or more knowledge exchange systems (100), one or more knowledge recipients (106), one or more knowledge experts (107), zero or more institutions (108), zero or more trainers (111 ) all of which may or may not be remotely located with respect to each other over a communications medium (105). The knowledge exchange system includes, but is not limited to one or more data stores (102) containing knowledge components and their characteristics (e.g., price, scheduled offering dates and times), a commerce system (103), a knowledge delivery system (101), and a security system (112). The knowledge exchange system may also include but is not limited to one or more a search engines (104), personalization engines (117), content management system (119), content index systems (116), invitation management systems (101), calendar systems (113), and rating systems (118).

Individual experts may create knowledge components and make them available for sale in the knowledge exchange system. The expert may manually interact with the knowledge exchange system to input the knowledge component. The knowledge exchange system may exist as an Internet based web service provided by a knowledge exchange service provider. The expert may interact with the service to provide the knowledge component and its characteristics to the knowledge exchange system. The experts may first be authenticated by the knowledge exchange system, prior to being permitted to contribute knowledge components to the system. The knowledge component may include, but is not limited to any document, or multimedia content provided by the expert.

The expert and institutions may provide the knowledge component(s) to the knowledge exchange system along with the characteristics of the knowledge component. The communications may be secured (authenticated and encrypted). The characteristics that must be provided include the title of the component or some unique identification of the component, and the price of the component including zero cost. Other characteristics that are optional, include the knowledge component description, expert's name, experts affiliations, whether the component is to be obtained via live, archived, or self-paced methods, the number and titles of each knowledge sub-component, to name a few. A knowledge component may include, but is not limited to multiple sub-components. For example, a course with the title of cave diving may be held in several sessions on different dates and time, live over the Internet. Each of the sessions may have their own title, description, scheduled delivery dates, or other characteristics.

The invention describes a process by which institutions may register to become content providers and participate in the knowledge commerce system. The invention describes a system that fully automates the process of registration for trainers, experts, recipients, and institutions such that human intervention between the user and the knowledge exchange service provider is not necessarily required. Automating the institution registration process is helpful to facilitating the creation of knowledge commerce marketplaces and is a key idea included in the invention.

Institution registration provides the institution with specific capabilities and benefits. The institution can offer many knowledge components for sale. Institutions are provided with an administrator account that permits the institution administrator to change, reschedule, and alter the knowledge exchange component and corresponding characteristics. The institution administrator is permitted to pre-register new members of the institution with the knowledge exchange service provider. The institutional administrator is provided with delegated administration privileges for all knowledge components offered by the knowledge exchange system on behalf of the institution. Furthermore, an institution account provides with it an institution page for branding or co-branding opportunities. Furthermore, an institutional account allows the institution to automate the content contribution process to the knowledge exchange service provide, thus allowing for business-to-business interchange. Delegated administration allows an institutional administrator to control institutional membership, institutional user authentication to the system and authorization for access to knowledge components, as well as manage all aspects of the institutional contributed content and schedules of when the knowledge components may be delivered or control the general availability of knowledge components.

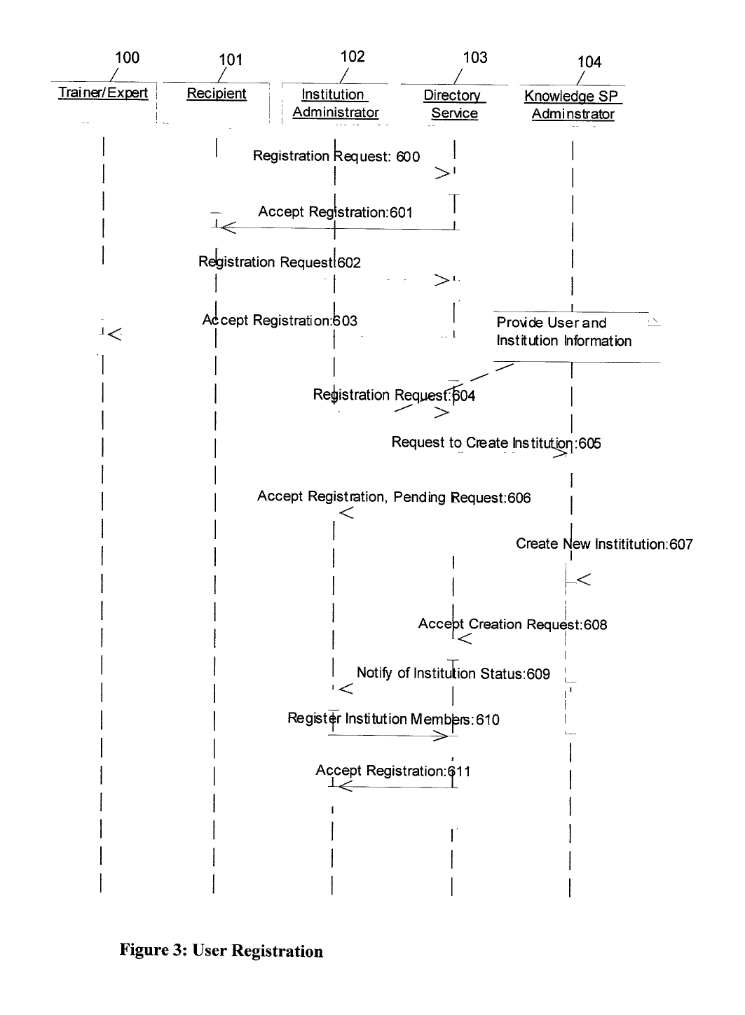

FIG. 3 shows the registration interactions between the trainer or expert (100), recipients (101), institution administrators (102) with the knowledge exchange system. In particular, users send a Registration Request (600, 602, 604) to the directory service (103) component of the knowledge exchange system. Note that the directory service component of the knowledge exchange system may be implemented using a relational database as a foundation, as is commonly done in the computer industry. Thus, the directory service component may be also considered to be a relational database, but is referred to as a directory for conceptual convenience. In the case of the trainer/expert or recipient, registration requests are acknowledged with an Accept Registration interaction (601, 603). However, in the case of an institution, the institution administrator specifies during the Registration Request (604) that he/she desires to establish an institution account with the knowledge exchange service. This presumes that the institution administrator has already viewed the pricing plans offered by the knowledge exchange service provider, and has selected a service plan. The request is sent to the knowledge service provider administrator in interaction 605. The Registration Request is accepted (606), but pending until the institution is accepted and created by the knowledge exchange service provider administrator, as illustrated in interactions 605, 607, 608 and 609. The knowledge exchange service provider administrator determines if the institution request is valid, and decides to either accept or reject the request. The institution administrator may be notified via interaction 609, which may, but is not required to be an immediate response if the decision is automated, or may but is not required to be delivered via email if the decision relies on a human decision. In either case, the user interacts with the service and not necessarily a human to register as an institutional user. Once accepted, the institution administrator account is established.

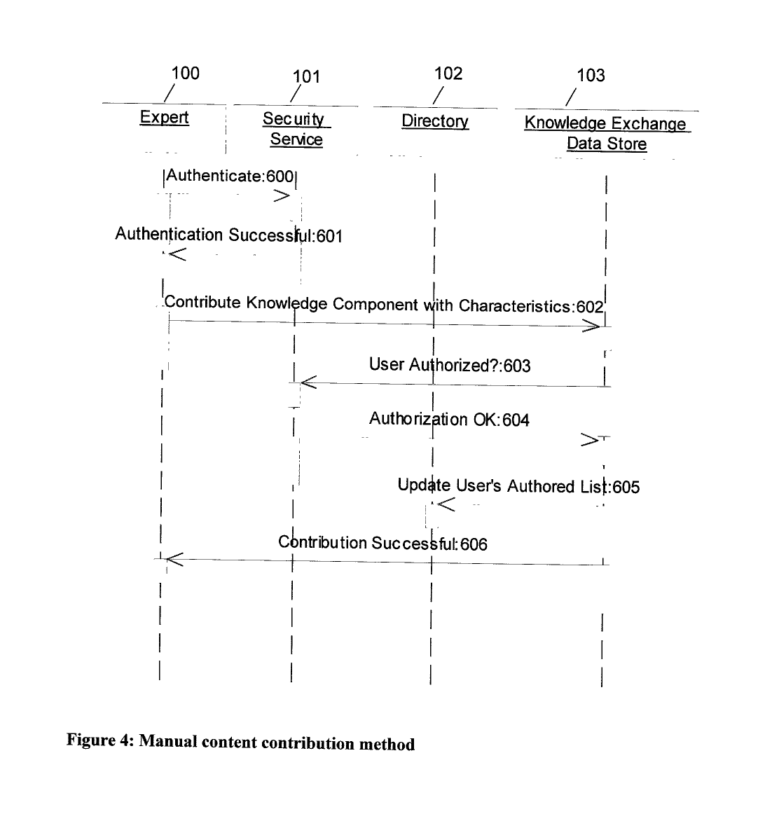

FIG. 4 shows the process by which content is manually contributed by experts. Experts are first authenticated with the service in interaction 600, 601. Experts are then brought through a series of forms in which the expert can provide the characteristics of the knowledge component being contributed (interaction 602). The knowledge exchange data store (103) interacts with the security service (101) to determine if the user is authorized to provide the content contribution in interactions 603 and 604. If authorization is complete, the user's profile in the directory (102) is updated to reflect that the knowledge component has been authored by the authenticated user (interaction 605). The user is finally provided with a successful notification message via interaction 606.

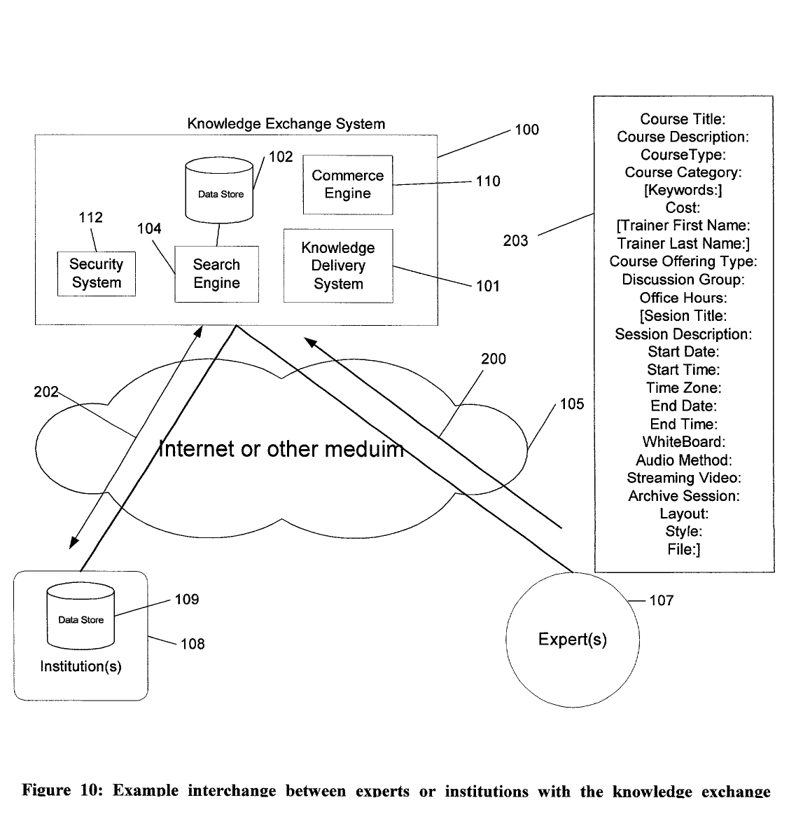

For example, the expert may provide the information shown in FIG. 10, flow 200 that contains the information in 203 to the knowledge exchange system. 203 depicts only the knowledge characteristic names (attributes) and not the values associated with the attributes. The information contained in 203 is an example of the type of knowledge characteristics that may be defined by an institution or expert. All those attribute names in 203 that are surrounded by square brackets [ ] may be repeated one or more times. For example, zero or more keywords may be defined for the knowledge component course. Keywords are words that describe and are associated with the knowledge component. The keywords enable the search engine to more quickly and accurately provide users with knowledge component information that matches their interest (search engine query). 203 shows a knowledge component that includes, but is not limited to a course that may be created by the expert or institution. The course may have a course title, description, type, category, zero or more keywords and a cost maintained by the knowledge exchange system. Furthermore, the course may have one or more trainers, a discussion group and office hours where the trainer may be available for consultation. For each course, there may be one or more sessions. Each session may have a session title, description, start and end dates and times and time zone (for live courses), option to use a white board as part of the session, the selection of an audio method, whether it be streaming based or telephone conference based, the selection to include streaming video, the selection to archive a live session, selection of the layout and style of the presentation, and the file (or files) itself that contains the knowledge component. The files may contain any kind of information and be of any kind of file type, such as a set of slides (e.g., Microsoft PowerPoint), a written document (Microsoft Word or Lotus WordPro), a spreadsheet (Lotus 123, Microsoft Excel), Adobe Acrobat pdf file, to name a few.

The information in 203 may not all be contained in one flow or interaction between the expert and the knowledge exchange system. For example, the expert may first define a course providing only the course information. Later the expert may create one or more sessions for the course, using a different interaction. The expert may manually enter or update the knowledge component and or characteristics, such as offering dates and times for live presentations, at any time to keep the information up-to-date. Alternatively, the user may provide all of the information in one flow. Finally, it is noted that for the purposes of the invention herein, the only needed characteristic is the knowledge component name or some such unique identifier. Note that for the b2c commerce model, the cost characteristic may be needed. All other characteristics are optional. As an alternative to manually providing the knowledge components and component characteristics, the exchange of this information between institutions and the knowledge exchange system may be automated. Automatic content contribution by institutions is an important attribute of the invention because it allows for the creation of fluid, more efficient knowledge market places by eliminating human intervention in the knowledge commerce process. FIG. 10, flow 202, shows the automatic content contribution flow and thus comprises a business-to-business interchange model. The content of the flow 202 can be similar or identical or very diverse from that of 203. If the interaction is automated, then 203 is may be considered a document for interchange. The attribute/value pairs contained in 203 may be written in the Extensible Markup Language (XML).

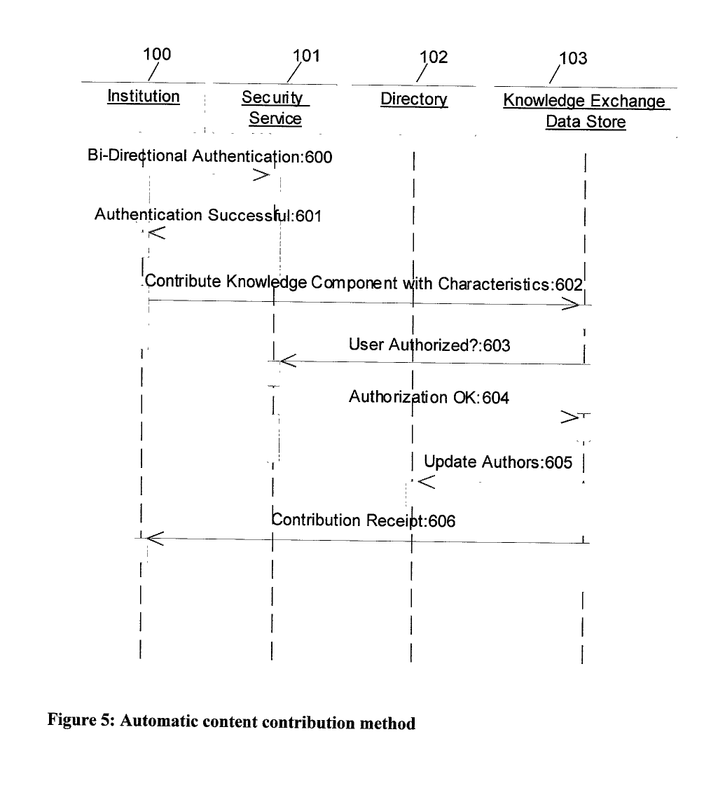

FIG. 5 shows the automatic content contribution process. The institutions and the knowledge exchange system may establish a secure communication process by which the parties may authenticate and encrypt the document interchange. Secure communications for the interchange can be established using available encryption and authentication technology, known to anyone skilled in the art. For example, the institution and the knowledge management system may dynamically establish a bi-directional Secure Socket Layer connection (SSL) that provides for bi-directional authentication and encrypted communications. Thus, prior to document interchange, the institution and knowledge exchange system may establish secure communications. Interaction 600 and 601 illustrate the authentication process of the institution (100) to the knowledge exchange security system (101), and the knowledge exchange system to the institution (bi-directional authentication).

The institutions may transmit the document to the knowledge exchange system whenever new or corrective adjustments need to be made to the institutions knowledge components contained in the knowledge exchange system. The knowledge exchange system may first authenticate the originator of the document, receive the document (interaction 602), verify if the user is authorized for the operation (603, 604), optionally update the directory entries for all appropriate authors (604), generate a receipt for the document, optionally send the receipt to the originating institution (606), optionally log the interchange for audit purposes, and apply the knowledge component information including characteristics to the data store. The order of the steps is not significant. However, the authentication and decryption (if used) may occur first. If there are errors in the document, the knowledge exchange system may not apply all or part of the document contents to the data store, and may generate errors in a receipt to be sent back to the originating institution. The directory (102) is optionally updated such that trainers are correlated to the knowledge components they teach or have authored. By correlating the knowledge components with the trainer in the directory, the trainer is provided with a personalized view of the knowledge exchange service. For example, the trainer may but is not limited to be shown a knowledge component administration page listing only the courses for which he/she is the author.

The possible scenarios with which knowledge components are contributed or managed in the knowledge exchange system can warrant the user of a content management system. FIG. 1 shows that a content management system (119) may be included in the knowledge exchange system (100). A content management system can provide versioning control of the content contained in the knowledge components. For example, if a self-paced knowledge component is contributed to the system, and recipients are in the process of receiving the knowledge component and the author simultaneously would like to update or modify the knowledge component, a content management system could help the author determine if the modifications should be applied so that the active recipients get the updated knowledge component immediately, or whether the updates should be applied only after the active recipients have completed the existing knowledge components. There are many other possible policies for applying the updates. For example, the updates may be applied only to new recipients that newly enroll in the knowledge component. The content management system can also provide support to knowledge component contributors to help them tag their knowledge components against an appropriate ontology. Content management systems may be integrated with ontologies so that content that is contributed to the knowledge data stores may be tagged appropriately, thus improving the ability for the system to match user interest with available knowledge components. The content management system may also provide the knowledge exchange system provider with a way to insert contributed content through a workflow process whereby the knowledge components may be reviewed and edited by an editorial staff, quality control group, legal department, and or financial organizations that may be operated as part of the knowledge exchange system provider. Using a workflow process to allow contributed knowledge components to be reviewed by different organizations can result in obtaining higher quality knowledge components and content. A workflow process may also involve cooperation of the experts and or authors of the knowledge component and the knowledge exchange system provider. For example, the expert may contribute a knowledge component to the knowledge exchange system. The component may be brought through a workflow process and be reviewed by a legal group within the knowledge exchange system provider, which may send the content back to the expert indicating, for example, that the content may be offensive and must be altered, or will not be accepted by the knowledge exchange system provider.

Users may search for knowledge components by name or other characteristics. The search engine allows users to find knowledge of various types in the knowledge exchange data stores, and displays the characteristics. For example, a user may search for knowledge components for sale related to “diving” offered between specified dates and costing less than 100 dollars.

Several types of data stores may be defined and may be included in the knowledge exchange system. The private data store may hold knowledge components contributed by institutions or experts, along with their corresponding characteristics. The private data store permits only authorized users to access it, respecting their respective roles. For example, an expert may have write permission to a sub-portion of the private data store. A knowledge component recipient may have read access to a sub-portion of the private data store for which they have enrolled. Institutions and/or experts may interact directly with the knowledge exchange system, either automatically via document exchange, or manually by filling out forms online. Another data store may be an Internet data store that may contain knowledge component characteristics found by “crawling” the Internet looking for other entities offering knowledge components. That is, a computer program in the knowledge exchange system may periodically crawl the Internet (like an agent), looking for knowledge components and their corresponding characteristics. The crawler compiles the characteristics of the knowledge components found from the Internet crawl, and may advertise them via the search engine to users. This allows the knowledge exchange system to provide great depth of information and can increase the frequency with which users return to the knowledge exchange service. That is, users may be more likely to return to the knowledge exchange system to look for knowledge components. If users return to the knowledge exchange system, they are more likely to enroll in knowledge components that are offered from the private data store. To encourage this behavior, the knowledge exchange system may provide superior services to users for knowledge components offered from the private data store, as compared to those services offered by other institutions for the knowledge components contained in the Internet data store. For example, the knowledge exchange system may provide superior knowledge delivery tools. The Internet data store may be populated manually or via a web crawler.

Another types of data store may be a public one. In a public data store, experts may be provided authorized write access to sub-portions of the data store (minimally, the portions where they have contributed their knowledge components) but general users may be provided with read access. This allows the knowledge commerce system to provide users access to knowledge components without requiring that the user be authorized to access the corresponding knowledge components. Furthermore, users may not necessarily be required to register with the knowledge exchange system provider for access to knowledge components in the public data store. The public data store is used in the KIOSK application of the knowledge commerce system, explained later.

Search indices may be constructed using various knowledge component characteristics so as to enrich the search criteria, thus making it easier and faster for users to locate knowledge components of interest. Examples of indices that may be constructed include but are not limited to cost of offering, date and times of offering, keywords that describe the offering, rating value, offering trainer, institution, knowledge component type (University, adult education . . . ), knowledge delivery type (live, archived, self-paced) to name a few. The indices may be dynamically constructed and rendered into web page views for users to navigate and select knowledge components to explore or enroll. The search indices may provide a taxonomy of knowledge components based on one or more characteristics of the knowledge components contained in the data stores. The search indices may be used by one or more search engines to speed-up the retrieval of knowledge components that meet the search criteria. For example, a user may request from the search engine to find all knowledge components one scuba diving that cost less than $250 to attend and are provided from January to March. The search engine may interact with a keyword index to find all knowledge components on scuba diving, with a cost index to find all knowledge components costing less than $250, and with a date range index to find all knowledge components being offered from January to March. The search engine may take the union of all returned results from each indices and present the union to the end user as the search result set.

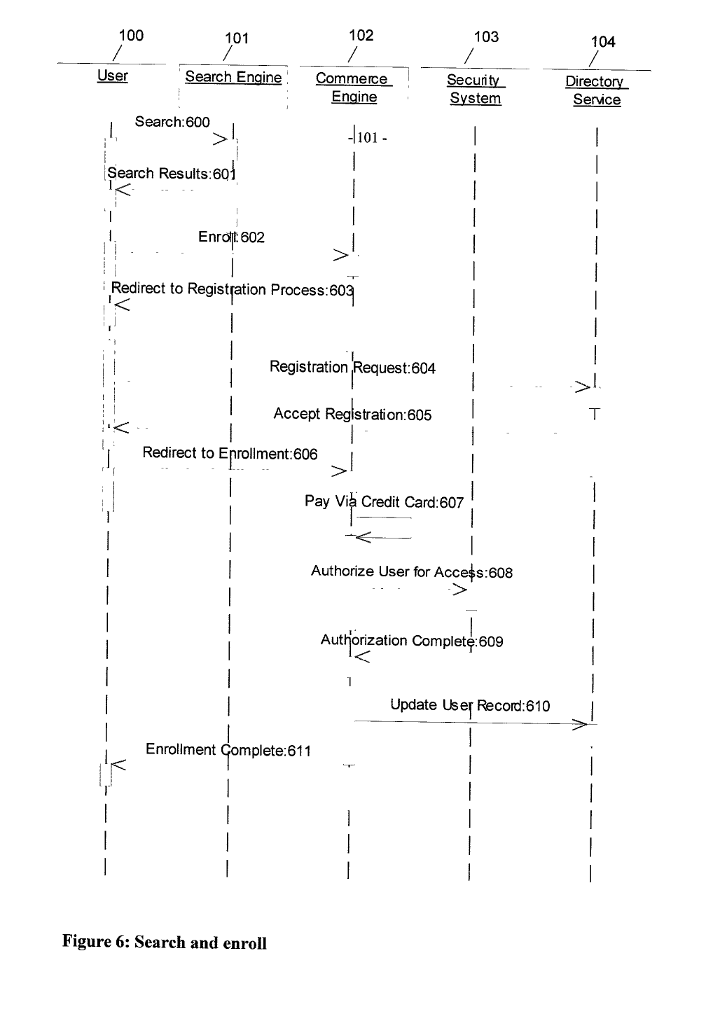

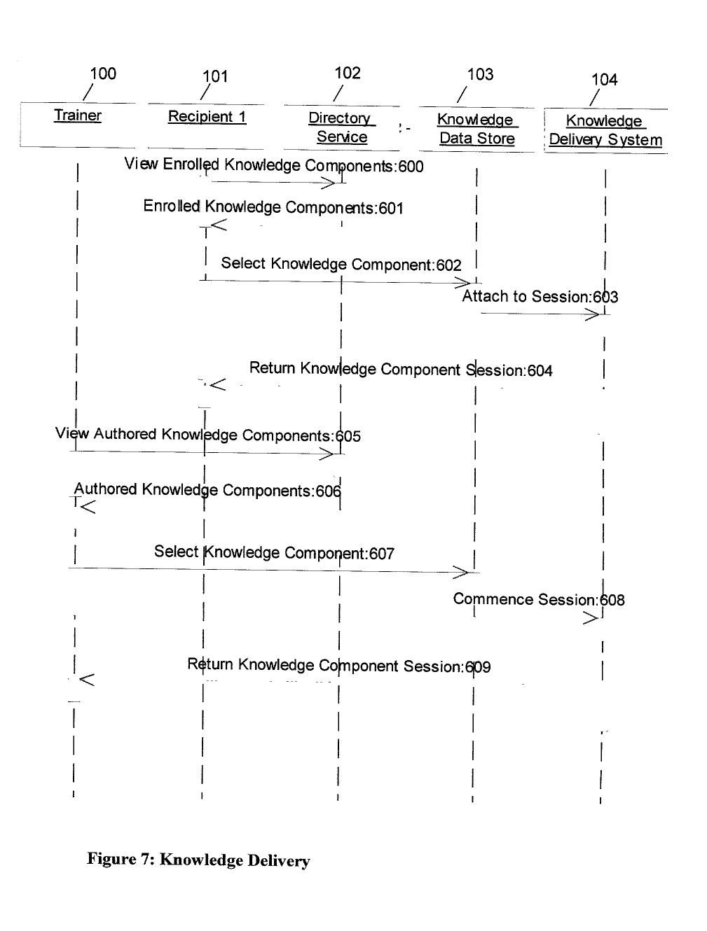

FIG. 6 illustrates the knowledge component search and enrollment process by which recipients locate knowledge components of interest, and enroll to obtain the knowledge component content. A user (100) interacts with the search engine to locate knowledge components of interest via interaction 600. The user may specify knowledge characteristics on which to base the search. The search results are displayed to the user via interaction 601. The user may request to enroll in the selected knowledge component via interaction 602 with the commerce engine (102). At this point, the user may not yet be registered with the knowledge exchange service, and as such be redirected to the directory service for late registration. The redirection is triggered when the user attempts to access the commerce engine server scripts. The security system may cause the user to be redirected to the registration process via interaction 603, so that the user can be identified to the knowledge exchange service. The user registers with the directory service via interactions 604 and 605, at which point the user is redirected back to the enrollment process in the commerce engine. The user interacts with a shopping cart to select the knowledge component to purchase, and is prompted to pay for the component by credit card via interaction 607. After payment is verified, the security system authorizes the user to access the knowledge component. The user's directory service record is updated to include the knowledge component as being enrolled by this recipient. Again, this information is used in personalization of the user's view such that when the user views the list of knowledge components to which they are enrolled, the page accesses the directory record to render a list of only those applicable knowledge components to which the recipient is enrolled. Interaction 611 notifies the recipient that the enrollment process is complete. The user now becomes the recipient and may obtain the knowledge via the knowledge delivery system.

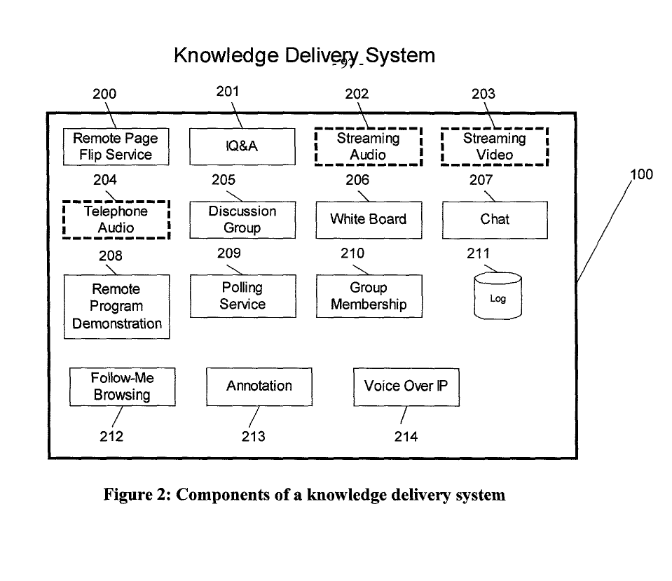

The user may have enrolled in a knowledge component that is obtainable via live, self-paced or archived methods. After enrollment, the knowledge exchange service is utilized for knowledge delivery. FIG. 2 illustrates the components of the knowledge delivery system. The knowledge delivery supports real-time, self-paced, and archived delivery of the knowledge components. The knowledge delivery system may include a remote page flip service (200), and Interactive Question and Answer (IQ&A) service (201), streaming audio (202), streaming video (203), telephone audio (204), discussion groups (205), white board (206), chat capabilities (207), remote program demonstration (208), polling service (209), group membership (210), a log for storing information related to the delivery of knowledge (211), follow-me browsing (212), and an annotation service (213). The disclosures of a co-pending application entitled “System, Method and Applications for Real-time Messaging over HTTP-based Protocols” includes descriptions of many of the collaborative applications that may be used as part of the knowledge delivery system. The co-pending application furthermore, can provide for the many collaborative capabilities without requiring that software be installed at the user, other than a browser. More specifically, the application specifies a real-time messaging technology that operates through firewalls, and does not require that the users install plug-ins, installation programs of any kind, use active controls including but not limited to Java, Java applets, Active X controls. The user simply may use a browser to utilize the many components included in the knowledge exchange system. The remote page flip service, IQ&A service, polling service, chat service and all applications in the co-pending application are incorporated herein by reference and may be included in the knowledge delivery system. The included reference provides, as example, how the page flip, IQ&A service, polling service, group membership and chat service may be used in an e-learning application of the invention. E-learning is an application of the knowledge commerce system invention.

The streaming and telephone audio services are used to support collaboration between the communicating parties involved in a live presentation. Typically, the trainer sends streaming video and/or streaming audio to the recipients so that the recipients may see and hear the trainer. The recipients may utilize streaming video and/or audio to speak back to the trainer. If a recipient asks a question of the trainer, for example, via streaming video and/or audio, the trainer may elect to rebroadcast the streaming content to the other recipients participating in the live presentation. The trainer may elect to answer the question only to the originating recipient. The trainer may elect to store the question and response for archived purposes.

Once a live session is completed, it may be stored and at that point may become re-classified as an archived session, if the trainer desires to make the live knowledge component available as an archived knowledge component. Streaming may also be used as part of self-paced knowledge delivery.

The knowledge delivery system may utilize chat service to allow recipients to hold chat sessions with each other at any time. Anyone skilled in the art is familiar with the features provided by chat. For example, the Microsoft NetMeeting software package provides for chat services. NetMeeting may be incorporated into the knowledge delivery system to provide chat capabilities amongst the recipients of a knowledge component. Alternatively, chat may be implemented as referred to in the co-pending application entitled “System, Method and Applications for Real-time Messaging over HTTP-based Protocols”, so as to use the real-time messaging system provided in that invention. This would allow for more ubiquitous access because the real-time messaging system uses standard Internet based protocols for communication and thus can operate through most firewalls.

The knowledge delivery system may utilize telephone-based audio instead of streaming based audio. The telephone-based audio produced during a live presentation may be recorded to a streaming file and included as part of an archived presentation. Anyone familiar with using a telephone bridge conferencing call is thus familiar with the features provided by telephone based audio.

The page flip service allows the trainer to flip the pages that are subsequently seen by the recipients. When telephone based audio is utilized, together with the page flip service, the page flips initiated by the trainer cause the pages at the recipient to flip to the page specified by the trainer. The preferred method to page flip, once the page has been selected, is to send the actual page to the recipients. Alternatively, the URL of the page may be sent to the recipients, at which point the application logic running at the recipient's machine may request the page to be fetched and then rendered at the recipients. In either case, as the trainer flips to a page, the recipient's view also flips to that same page.

When the page flip service is used with streaming based audio and/or video, the page flips may be embedded in the encoded stream, and as such are synchronized with the stream. Thus, if the encoding of the stream introduces a few second delay, the page flip is delayed an equal amount when it arrives at the recipients. The page flip event may be inserted into the stream at the trainer, become encoded at the source (trainer), and as such is delayed an equal amount as the video and/or audio produced by the encoding process. Again, this is in contrast to telephone based audio, where page flip events initiated at the trainer cause immediate page flips at the recipients. By tracking the delay introduced by the encoding process, all actions produced by the trainer appear to be synchronized with each other. For example, the streaming audio and video and page flip events are all synchronized with each other with respect to the recipients.

That page flip service may flip any portion of the screen, and does not necessarily have to replace the entire screen at the recipients. The trainer may page flip a small sub-area of the recipients view, at which only that sub-area is updated with the page flipped information. For example, a sub-frame of an html page may be page flipped by the trainer to update only that portion of the recipient's view with the page flip information.

In summary, two synchronization mechanisms are explained. The first is for telephone based audio, where there is no substantial delay between the trainer's audio and the recipients receiving that audio. The second is for streaming based video and/or audio, where there may be a delay, introduced by the stream encoding, between the trainer and the recipients. In the later case, the page flip service or other services may be synchronized with the trainer's encoded stream. The recipients would receive delayed, but synchronized page flips.

Note that the page flip service may provide such capabilities for live, self-paced or archived knowledge component delivery types. In a self-paced presentation, the page flip events may be embedded in a corresponding audio stream, for example. Alternatively, the page flip events may be timed and play-out with the same timing as they were created by the expert. Finally, an archived knowledge component may play back the page flip events just as in a self-paced presentation type.

The delivery system may include remote program demonstration. Remote program demonstration allows the trainer to send to one or more recipients the view displayed on the trainer's screen. That is, the trainer may be surfing the web or running a program on his/her computer. The view on the computer is sent to the recipients in a live training session, such that the recipients see what the trainer sees and can watch the trainer's screen activities in real-time. That is, all mouse movements and activities initiated on the trainer's computer are sent to the recipients. Remote program demonstration is a feature provided by the Microsoft NetMeeting software package. As such, the knowledge delivery system may incorporate NetMeeting of other similar type technology for the remote program capability.

The delivery system may include a group membership service. The group membership service may be utilized to track the connectivity of the users during a live presentation. For example, the trainer may be notified in real-time as to the number of recipients that are attached to the live training session at any given moment. The trainer may be notified if one or more members leaves the live training session or joins the session. Join or leave events may be a result of the user explicitly joining or leaving the session, or as a result of loss of connectivity between the trainer and the recipient(s). Group membership services may also provide the trainer with the identity of which recipients are participating in the knowledge delivery session.

The delivery system includes a logging capability to store information pertaining to the knowledge component delivery. For example, individual recipient responses to live polls may be stored in the log. The system may store the results of the quiz questions for each recipient in a database or log file, and provide automatic grading (scoring) services to the trainer or institution.

The delivery system may include an annotation system. The annotation system may enable a trainer to annotate slides or pages in real-time as they are shown to the recipients for live knowledge component delivery. The annotation system may also enable authors to annotate self-paced knowledge components so that during playback, the annotations are provided to the recipients. Also, archived knowledge components may also provide playback of annotations that were captured during live delivery. The annotation system allows any drawings, markups carried-out on the view page of the knowledge component to be viewed by the recipients on their local view of the page. The annotation system provides the same capabilities as a white board application, but does not necessarily require that the user startup a separate application, such as a white board. The annotations may be carried-out on the slides viewed by recipients. Also, recipients may collaborate by annotating their local slides and causing their local changes to be view by the trainer or all other participants during a live session. In this sense, the annotation system is another form of collaboration. The trainer may control which recipient is permitted to annotate a slide and may pass control from one participant to another. The trainer may terminate control to a participant at any given time. A recipient may give up the right to annotate a slide when the recipient decides they are complete and no longer need control.

The delivery system may include follow-me browsing capabilities for live, self-paced and archived types of knowledge component deliveries. Follow-me enables the trainer or knowledge component author to bring the recipients on a tour of pages including but not limited to the Internet. Follow-me browsing causes the recipients to view the same thing that is being viewed by the trainer during a live delivery, or the view authored by the knowledge component author for a self-paced knowledge components. For example, as the trainer navigates to a new page on the Internet, the recipients would also be brought to the same page. As the trainer interacts with the page, causing additional navigation, the users would also be navigated to the new pages, just as the trainer. In this manner, the recipients view tracks that of the trainer. The trainer need not interact with his or her view, but can continually push new pages to the recipients. The recipients may simply be shown various pages, as the trainer pushes them to the recipients.

Trainers and experts are able to incorporate polling and/or testing into the knowledge delivery. The system may operate as follows. The may trainer use the knowledge exchange system to view a table of contents that lists each page in sequential order, that is part of the knowledge component. The trainer may insert a poll or question at any point in the knowledge component such that the poll is presented to the recipients when the trainer or expert desires. Questions for the poll can be developed prior to the knowledge delivery or during a live knowledge delivery session. In either case, the expert or trainer may interact with a form to request to create a question. A web form is presented to the trainer/expert requesting the question text, number of possible choices, the choices themselves, and optionally the correct answer, if the question is of type multiple choice and has a correct response. A web page is constructed, stored with the session files, and a reference of the web page is inserted into the table of content at the location desired by the trainer/expert. Alternatively, the questions may be developed as part of the knowledge component authoring process. For example, the knowledge exchange service provider may provide Microsoft PowerPoint slide templates that can be used by content authors or experts to insert questions during the content authoring process. The slide templates contain small script code that coordinates with the knowledge exchange system to support the logging of test questions, as well as other features. In summary, the questions may be developed and incorporated into the knowledge component on-line or on-the-fly using the knowledge exchange system, or may be developed off-line apriori using standard authoring tools along with question templates provided by the knowledge exchange service provider.

During a live knowledge delivery, the trainer may click on the reference to the page in the table of contents portion of the screen, and the question is delivered to the recipients to answer. Results from the poll are immediately returned to the trainer and may be represented in graphical format. The results are returned via the polling service described in the co-pending application entitled “System, Method and Applications for Real-time Messaging over HTTP-based Protocols” already incorporated herein by reference. For example, the trainer may be provided with a graphical bar chart showing the number of users in total in the system (known at the trainer by the group membership service described in the co-pending application entitled “System, Method and Applications for Real-time Messaging over HTTP-based Protocols”) and for each possible multiple choice, a bar showing the number of users that selected each choice. Thus, the trainer is provided immediate feedback to the poll.

During a self-paced knowledge delivery, the question is posed to the recipient at the points where the expert placed the question in the sequential order of web page delivery.

When recipients are prompted with a question during a poll or testing situation, the recipient may select a response or choice, or type a response to the question, and submit the result. The knowledge exchange service may store the results of the response in a database, and provide the results to the trainer, as described above.

The questions and responses to the questions may be stored in a database for tracking, certification, and/or scoring purposes. An example system that provides for the persistence of scoring results is described. When a trainer or expert develops a poll or question that is to become part of the knowledge delivery, the knowledge exchange service inserts the characteristics of the poll/question into a database and associates it with the knowledge component session identifier. For example, a multiple-choice question may be described in XML as follows:

<sku>99</sku>
<coffID>93</coffID>
<sessionID>345</sessionID>
<multichoiceQ>

<qnum>7</qnum>
<question>Who is the president of the United States</question>
<choice1>Abraham Lincoln</choice1>
<choice2>George Washington</choice2>
<choice3>William Clinton</choice3>
<answer>3</answer>

</multichoiceQ>

The record identifies knowledge component identification information for which the question applies (sku, coffID, sessionID), the poll or question type as a multiple choice question (multichoiceQ), includes the question number, the question and choices, as well as the answer.

When a recipient responds to the poll or question, the users selects the choice he/she thinks is correct and the knowledge delivery service may record the user's response in the database and aggregate the response with other recipient responses. If the knowledge delivery is live, the responses or aggregated responses may be immediately forwarded to the trainer. The format of the data stored for the recipient's response may be as follows, again in XML format:

<userid>Jdoe@acm.org</userid>
<sku>99</sku>
<coffID> 93</coffID>
<sessionID>345</sessionID>

<qnum>7</qnum>
<response>2</response>
<answer>3</answer>

Associated with the recipient JDoe is the knowledge component to which the question belongs, the question number, the recipient's response or choice to the question and the answer to the question.

The knowledge exchange service may provide automatic and instantaneous grading services to the trainers as the recipients provide responses. Automatic grading is carried-out by the knowledge exchange service by compiling the user's responses and comparing them to the questions, obtained from the stored information described above. From the information stored in the database, individual grades may be assigned to individual recipients, bell curves may be drawn, medium, means, averages, standard deviations may be automatically calculated and presented to the trainers instantly or at any time.

Some certification programs may require verification that the user has taken delivery of the knowledge component. Since knowledge components may be delivered to users at locations remote from the trainer, the ability to verify that a user is continually participating in the knowledge delivery is required. For live knowledge delivery sessions, this may be accomplished by inserting frequent polls or questions into the live training sessions. If a user stops responding to the poll or questions, then the trainer may take notice of the event and potentially not certify the user as have completed delivery of the knowledge component. Note that the trainer may be provided with real-time group membership status and thus know if a user is still connected to the session, but not replying to the poll or questions.

For archived and self-paced knowledge components, verification may be carried-out by again inserting questions into the knowledge component such that the user is required to make responses. Furthermore, the time taken to complete the archived training may be tracked to assure that a reasonable and comparable amount of time was taken to complete the knowledge delivery. Finally, the recipient actions may be recorded to assure that the user did view all materials associated with the knowledge component delivery.

The knowledge exchange system may include a knowledge rating system, as shown in FIG. 1. Recipients that have completed a knowledge component may be permitted to rate the knowledge component. The knowledge component ratings may become available for other users to view and can be used to evaluate the value of the knowledge component. The rating information may be available either explicitly as was contributed by recipients, or aggregated, such as in a scale of 1-10, where 1 is the best and 10 is the worst. Multiple rating criteria may be used and displayed. The rating system may be coupled with the search engine results, such that the rating characteristics may be utilized as criteria for searching for knowledge components. Users may use the rating information to determine if the knowledge component is of value to purchase. The rating system is important to the knowledge commerce system because it allows the market to determine which knowledge components are of value, thus stimulating a knowledge marketplace. The rating system allows experts that are not members of a highly branded institution, to make their knowledge components available for sale on the knowledge exchange system, and for potential recipients to become comfortable with purchasing the knowledge components from non-branded sources. The recipients may rely upon the rating information, such as the trainer or expert credentials as advertised on the trainer's page, to make purchasing decisions. The rating system may also include recipient's free form comments. Recipients may be provided with incentives to provide ratings to knowledge components that they have completed. For example, recipients may receive a discount for enrollment in another knowledge component, or receive frequent flyer miles, coupons for discounted purchases at other e-commerce sites, etc. Finally, knowledge component ratings may be carried-out by independent organizations that are known to be unbiased and as such are reliable in terms of credibility or rating. The rating information may be provided in search or indices results for easy viewing by potential recipients. Amazon.com currently providers for a rating system for rating the quality of books. The rating system may include, but is not limited to a score of 1-5 stars where 5 stars represent the best class of book. Users are able to rate the books by selecting a number from 1-5 and providing a textual comment that is viewable by others in the search results. One deficiency in this rating system is that anyone can rate a book. That is, a user that may have not read the book can still rate the book. In the rating system included in this invention, users cannot rate a knowledge component unless they have completed delivery of the knowledge component. This improves the credibility of the rating results, since only those recipients that have experience the knowledge component are allowed to provide a rating for the component.

The knowledge exchange system may provide invitation management enabling a trainer or expert to invite a closed group of users to a knowledge component session. FIG. 15 shows an example scenario whereby a trainer or expert may create an invitation that may be sent to the closed set of recipients. Other possible scenarios exist and FIG. 15 is provided as an example scenario. In this scenario the expert or trainer (100) authenticates with the knowledge exchange system provider in flows 600 and 601, and then selects the knowledge component or components for which to create an invitation (602). The user may then be verified to determine if they have authorization to create an invitation for the respective knowledge component(s) shown in flows 603 and 604. The user (100) then may request the creation of an invitation for the knowledge components shown in flow 605 with the calendar system (102). The calendar system supports contact management as well as the ability to schedule live knowledge in personal, as well as shared calendars. The calendar system (102) may provide the user (100) with the invitation shown in flow (606). The user (100) may then select the recipients of the invitation (607) and request that the calendar system send the invitation to the recipients (608). This scenario only provides an example interaction. There are many possible order and types of interactions to provide invitation management.

Likewise, a user that receives an invitation may interact with the knowledge exchange system as shown in FIG. 16. In FIG. 16, the user (100) may receive an invitation shown in flow (600) from the calendar system (103). The user may accept the invitation, shown in flow 601. The user may then be required to enroll in the knowledge component shown via flow 602 if the knowledge component has a non-zero cost to recipients. If the user is not yet registered with the knowledge exchange service provider, he or she may do so shown in flows 603, 604 and 605. The user may not be required to register with the knowledge exchange system if registration for the knowledge component is not required. Afterwards, the user may be redirected to the enrollment process again, as shown in flow 606, where the user may be requested to pay for enrollment shown in flow 607. The security system (102) may then authorize the user to access the knowledge component shown in flows 608 and 609 with the commerce engine (101). The commerce engine may interact with the directory service (104) so that the directory service may update its user record to indicate that the user (100) is not a recipient and has successfully enrolled in the knowledge component, as shown in flow 610. Note that the capabilities of the directory service may be replaced by a standard database or file system for implementation authorization of knowledge components to recipients. Finally, the commerce engine notifies the user that the enrollment is complete, shown in flow 611, and the recipients (100) may now attend or receive the knowledge component, as shown in flows 612. Note that there are many possible scenarios to carryout this capabilities and FIG. 16 shows one such possible scenario.

The knowledge commerce system may provide for security. Network level security, if necessary, may be implemented via virtual private networks (VPN). For example, an institution may desire to use the knowledge commerce system to delivery proprietary knowledge only amongst members of the institution. The knowledge components may be of a highly sensitive nature, and as such, warrants the use of network level security, such as VPNs. In this case, the knowledge exchange service provider may provide to the institution a VPN connection to the knowledge exchange system, such that all communications between the knowledge exchange system and the institution's networks are secured at the network level. Furthermore, the knowledge exchange system may not permit the knowledge components being offered by the institution to be listed in the search results or indices queried by non-institution members. In this manner, non-institution members never know about the institution offered knowledge components. Institutional members, however, will be able to search for and find knowledge components offered by their institution as well as other experts and institutions. Alternatively, the knowledge exchange service provider may implement a separate instance of the knowledge exchange system whereby only members of the institution are served and knowledge components offered by that institution are offered.

In addition to or instead of network level security, application level security may be provided. For example, the knowledge exchange system may provide user authentication. Authentication may be established via password and userid, digital certificates issues as part of a public key infrastructure, biometrics, retina scans or any other means of authentication. Communications may be encrypted between users and the knowledge exchange system, as well as between users themselves. A typical means of encrypting communications over the Internet is to use Secure Sockets Layer (SSL) communications protocol, later known as Transport Layer Security (TLS). The communications may be carried-out using increasing key lengths (e.g., 128, 512 bits), thus increasing the level of encryption. Encryption may be important where confidential business communications are being carried-out, or high valued knowledge components are being delivered.

Digital certificates provide non-repudiation, which may be important in quiz taking or polling situations where the user may later attempt to deny selecting a particular choice or providing a particular answer. The knowledge exchange service provider may thus prove that the user did make a particular choice and as a result obtained a particular grade.

Also part of the security system is authorization. Authorization associates privileges to users. When a recipient enrolls in a knowledge component, the recipient is authorized by the knowledge exchange system to access the knowledge component files and participate in the knowledge delivery.

An important feature of the knowledge commerce system that is integrated with the authorization system is delegated administration. Delegated administration permits one or more members of an institution to have higher privileges with respect to the members of the institution. For example, a delegated administrator of institution X may have privileges to create new or delete user accounts in the knowledge exchange system, or reschedule the date and time that a live knowledge component offered by the institution is to be delivered. Delegated administration and authorization are highly dependent on the design of the system, and as such are discussed together.

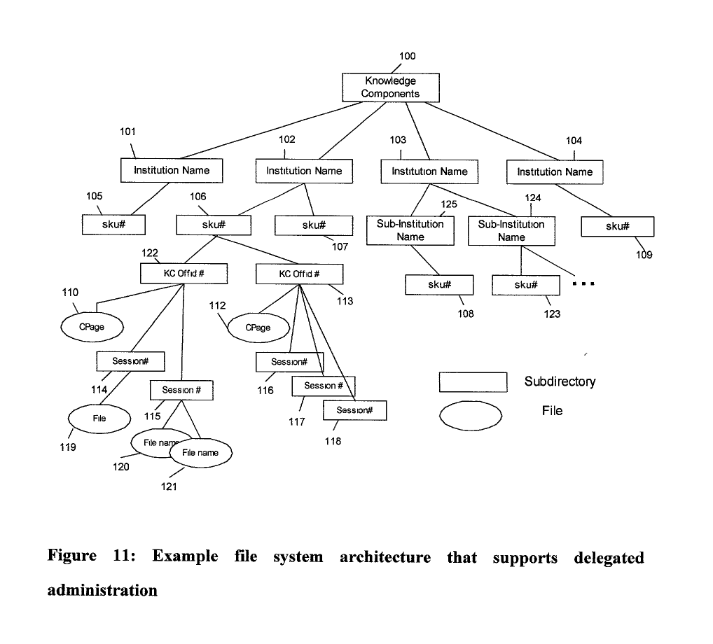

The delegated administration design requires coordination in the directory services as well as in the file system where the knowledge components are stored. An example file system structure is illustrated in FIG. 11. In this example, all knowledge components may be stored under the root subdirectory 100, knowledge components. The names of the subdirectories 101-104 represent the names of institutions, and the subdirectories 124 and 125 represent the names of sub-institution directories. For example, the institution name for the subdirectory 101 may be “Harvard”. The institution name for the subdirectory 102 may be Boston University. A sub-institution name may be the financial department and or personnel department under Harvard (101). Under each institution's subdirectory may be subdirectories, containing either sub-institution directories, or one for each knowledge component. Each knowledge component may be identified by a unique number or sku. Each knowledge component is stored under a subdirectory equal to the sku. For example, the sku represented by subdirectory 105 may be the subdirectory “23”, under which the knowledge component offering identifier subdirectories reside. Knowledge component offering identifiers are the parent subdirectory of instances of the same knowledge component that may be offered at different dates and times. For example, a course on cave diving may be offered in the Spring of 2000, and then again in the Fall of 2000. The knowledge component content is the same in each case, but the offering instance is different. Different recipients will be authorized to access the different knowledge component offerings. Thus, the subdirectory 106 may be “22”, and may represent a cave diving course. The subdirectory for the Spring offering of the course may be any unique number, “54” for instance, and be represented in the figure by 122. The Fall offering of the course may be located under subdirectory “55”, represented as 133 in the figure.

Under each knowledge component offering identifier subdirectory may be subdirectories for each session and the knowledge component page. Each session subdirectory may be named as unique number, under which the actual knowledge component files reside. For example, under subdirectory 122, knowledge component page (Cpage) 110 resides, along with subdirectories 114, 115. Under subdirectory 114 resides the knowledge component file 119, which may be a presentation, spreadsheet, or any knowledge component. One or more files may be stored in the session subdirectory as illustrated in subdirectory represented as 115.

This file system structure supports delegated administration in the following manner. First, when a recipient enrolls in a knowledge component, the knowledge exchange system authorizes the recipient to access the file system starting at the specific knowledge component offering identifier to which the recipient enrolled. For example, if the recipient enrolled in the Spring offering of the cave diving knowledge component, the recipient would be authorized to access the subdirectory represented by 122 in FIG. 11, for instance. Authorization is inherited by default. Thus by authorizing the recipient to the subdirectory represented by 122, the recipient is authorized for all subdirectories and files that are children of 122 and its children subdirectories 114, 115, and their children files 119, 120, and 121.

When a user is assigned delegated administration privileges for a given institution, the user is given authorization to the institution's subdirectory. For example, a delegated administrator is given authorization to the subdirectory 101 in FIG. 11. Since by default, privileges are inherited, the user has the privileges over all knowledge components offered by the institution. The delegated administrator may update, delete, and modify the knowledge components for example.

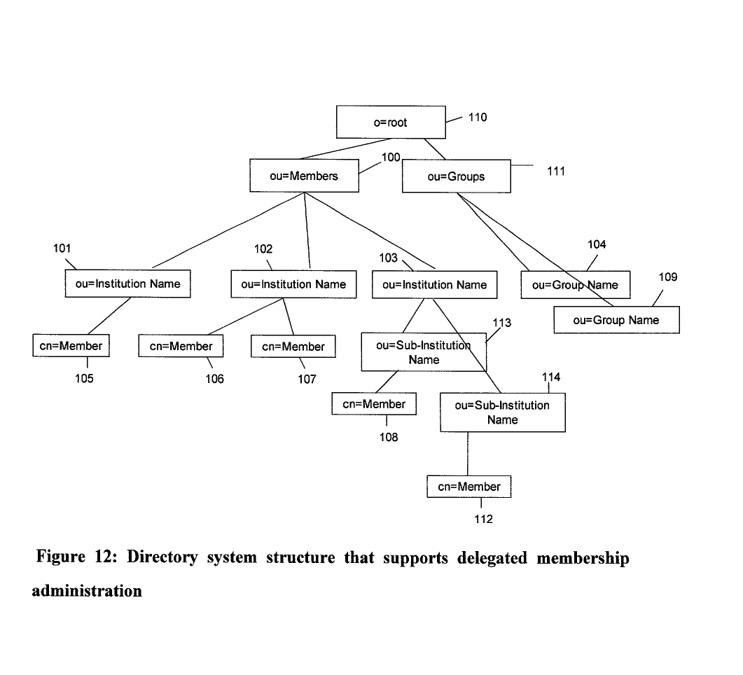

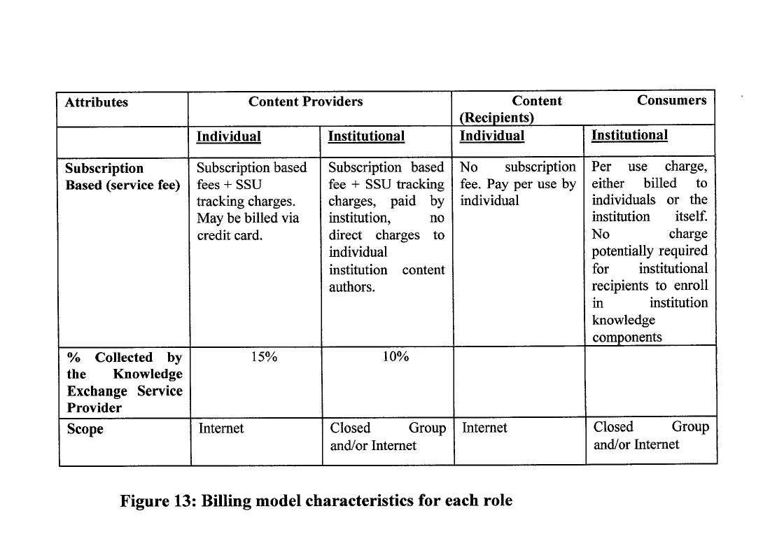

Delegated administrators also need to be able to control their institution's membership in the knowledge exchange system, including control over userids. This support is provided in the knowledge exchange system by designing a hierarchical membership structure in the directory services. FIG. 12 illustrates the directory services structure that supports delegated membership administration. For example, an institution named Harvard may be represented as node 101. Thus, the organization unit (ou) may be equal to Harvard in the directory. All members of Harvard are listed as children canonical names (cn) under the ou=Harvard. The member record, uniquely identified by its cn is represented as 105 in FIG. 12. Next create an ou under ou=Groups (111) that is named by the institution (Harvard, in this example). Let us assume the administrator's cn is Jdoe. It is assumed that the delegated administrator's membership record is already located under the directory path such as cn=Jdoe, ou=Harvard, ou=-Members, o=root. Next create an mgroup record called cn=institution name appended with “Adm” under the institution name under the ou=Groups. For example, the path would be cn=HarvardAdm,ou=Harvard,ou=Groups,o=root. Add a memberOf object, e.g. cn=JDoe, under the mgroup (cn=HarvardAdm) just created in the previous step. Add the mgroup (cn=HarvardAdm) to the access control list (ACL) contained in the institution ou under the ou=Members node. For example, add the mgroup element to the ou=Harvard,ou=Members record. Now user Jdoe has membership administration privileges for all members contained under the institution. Delegated membership administration is described in publication “Membership Directory Group Scalability”, Microsoft Site Server Commerce, published April 1999, pages 5-16, http://www.microsoft.com/siteserver, and is included herein by reference. Note that FIG. 12 shows that sub-institutional membership may be supported, as shown in container 113 and 114. The ou containers 113 and 114 are sub-institutions of ou container 103, and allow the institutional members to be administered by different delegated administrators within the institution. For example, the ou container 113 may be named CitiBank, and the ou containers 113 and 114 may be named CitiBankFinance and CitiBankPersonnel respectively. Delegated administration may be assigned administrative privileges for all of CitiBank. Additionally, delegated administrators may be assigned to CitiBankFinance and CitiBankPersonnel such that each of these administrators has administrative capabilities only over their respective members. That is, delegated administrator assigned to ou container 113 would have administrative privileges over member 108.

The knowledge exchange system may provide personalization by leveraging the directory services. Users may be registered in the directory services as illustrated in FIG. 3. Thus, a user membership record exists in the directory for each user of the knowledge exchange service. Personalization may be achieved by associating information with the membership record maintained by the directory service. For example, a multi-valued attribute of the membership record may be “categories of interest”. The knowledge exchange system may store one or more knowledge component categories that are of interest of the specific user. As knowledge components are contributed to the system by institutions and experts, the user may be notified proactively of the availability of such components. Cross selling of knowledge components is also possible, where if a user has expressed interest in a specific knowledge component of a given category, then the user may be offered the opportunity to enroll in another knowledge component of the same category.

When knowledge components are contributed to the system, part of the process may entail the characterization of the knowledge components such that the components are categorized or classified against an ontology. An ontology is a classification hierarchy that may be structured as a tree or directed acyclic graph. An ontology provides an organization of concepts and specifies the relationship of various concepts within the ontology with other concepts within the ontology within a given domain. Ontologies may be created by anyone. There are also ontologies that have been developed by standards organizations or consortiums. For example, the open directory project found at http://www.dmoz.com and included herein by reference, show an example of an ontology that attempts to describe the concepts provided by the Internet as a whole.

After or during which a knowledge component is contributed to the system, the expert or other persons may classify the knowledge component against a respective domain specific ontology provided by the knowledge exchange system. This process is called tagging, as the component is associated with one or more concepts in the ontology. As new knowledge components are contributed to the system, other system users may be notified of the presence of the new knowledge components, if the user's categories of interest includes a concept tag that corresponds to that of the newly contributed knowledge component. Note that ontologies are often hierarchical in nature, and thus a user may specify a more general concept in the ontology, as a category of interest. Say, for example, the user specifies interest in concept A. Let us assume that in the ontology of reference, concept A is the parent and more general concept of concepts B, C and D. If a knowledge component is contributed to the system and tagged with the child ontology concept D, then the user that has expressed interest in the more general concept A, may be notified or made aware of the new knowledge component of category D.

Users may be notified by email or when they log onto the knowledge exchange service of knowledge components that satisfy their interests. Users may at any time update their category of interests record to expand or reduce their interests. Users may reference the ontology provided by the knowledge commerce system, when decided with concepts with which they are interested. When a user selects an ontology concept of interest, they may request to be notified of any knowledge components contributed to the system that are tagged with child concepts of the selected concept. Furthermore, when a newly registered user logs onto the system, they may be encouraged to specify their interests so that they will be notified of newly contributed knowledge components with which they may be interested.

The knowledge exchange system may use different ontologies depending on the type of domain over which the knowledge commerce system is implemented. For example, if the knowledge commerce system is implemented for use as an e-learning web site for musical history, then the ontology that may be utilized for the personalization aspects of the site may include an ontology of music history periods. In such a service, the user may express interest in specific music history periods and be notified when knowledge components containing content about those specific music periods becomes available in the system. An important feature of the system is that the system is ontology agnostic such that personalization within the system may be implemented using any one or group of ontologies, and the system does not require redesign to accommodate new and different ontologies.

Branding and co-branding of the institution may be provided by the knowledge exchange system in many ways. For example, when a member of an institution logs into the knowledge exchange system, he/she may immediately be brought to the institution page for the institution. The user would have the impression that the institution is the main provider of the service. The knowledge exchange service provider may also place their logo or other identifying information on the institution page resulting in co-branding.

Branding may also be indirectly achieved by restricting what knowledge components user may discover in the system. For example, users of institution X may not be permitted to see knowledge components offered by institution Y. Likewise, users of institution X may only be permitted to locate knowledge components offered by institutions A, B and C. This capability may be implemented by listing the permitted and/or non-permitted institutions in the user's directory record as one or more multi-valued attribute. For example, the user record may contain an attribute called “permitted institutions”. When the user searches for knowledge components in the search engine, if the search results contains knowledge components offered by institutions that are not listed in the “permitted institutions” attribute for the user record, then those knowledge components would not be displayed in the search results to the user. Note that this feature can be implemented only if the user is already authenticated to the service. This can be enforced by restricting some search engine results to be shown only to authenticated users, even if the members are weakly authenticated such as by authenticated cookies. That is, institutions that desire to restrict the knowledge components accessible to their members would not allow their knowledge components to be displayed to users that have not already authenticated themselves with the knowledge exchange system. Anonymous users would not be permitted to see the institution's knowledge components in search engine results.

Co-branding may also be achieved by providing a means by which the knowledge commerce system may be presented to institutional members as if it where being provided to a large extent by the institutions itself, rather than the knowledge commerce provider. This may be implemented using Internet web technologies using two key techniques. First, let us assume that the institution's name is Xyz Corporation, and their Internet URL is www.xyz.com. Assume that the knowledge commerce service provider is accessible on the Internet using the www.kcsp.com URL. The knowledge commerce provider may add an additional DNS (Directory Network Services) record that resolves the name www.xyz.kcsp.com to the same IP address as www.kcsp.com, or to an IP address that is hosted by the knowledge commerce service provider. This provides a means by which institutional members may access and get a view of the xyz corporation's institutional area in the knowledge commerce service provider' system, such that the member is lead to believe for the most part that xyz corporation is providing the knowledge commerce service.

The second technique helpful in providing a custom institutional view of the knowledge commerce service providers system to institutional members, is to conditionally include portions of the web page that are provided a priori by the institution. For example, the institution may provide to the knowledge commerce service provider a header, left, right and footer portion of a web page that is strongly branded with the institutions look and feel, as well as presentation layout, including colors, graphics, and other presentation characteristics. The institution may also provide a Cascading Style Sheet or XML Style Sheet that may control the look and feel, as well as layout of the page. The knowledge commerce service provider enables the institutional support within the web service by conditionally rendering the include files and/or style sheets when the knowledge commerce service provider system detects that a user has arrived at the site using the URL that includes the institution's name. For example, if a user types www.xyz.kcsp.com to navigate to the knowledge commerce service, the knowledge commerce service may detect (by examining the http header, for example) the institution name in the URL, and may conditionally and dynamically render the page using the include files and/or style sheets, for example, provided by the specific institution. Using these techniques or other similar such techniques, the knowledge commerce service provider may provide custom branding or co-branding to institutions dynamically, as users access the knowledge commerce system.

Users are required to accept usage policies for different types of operations that they are permitted to carry-out. For example, after a new user completes the registration process, the user is redirected to a “user policy” page where they may either accept or reject the user policies. If they reject the user policies, they are not permitted to go further into the portion of the knowledge exchange system. Every time the user returns to the knowledge exchange system, they are presented with the user policy page, until they accept the policy. If they accept the policy, they are permitted to enroll in knowledge components.

Furthermore, when an expert or institution expert member desires to create a knowledge component in the knowledge exchange system for the first time, they are redirected to the “authors policy” page where they are prompted to accept the author's policy. The user is not permitted to contribute knowledge components to the system without first accepting the author policy.

There are several types of web pages in the knowledge commerce system that provides information for the users to make informed purchasing decisions. The institution page contains branding information regarding the credentials of the institution. The delegated administrator for the institution may have authoring privileges over the institution page.

The trainer page may contain information pertaining to the credentials of the trainer. For example, the trainer page may contain the list of knowledge components provided by the trainer, along with their associated ratings. The page may contain the trainer's curriculum vita or resume, teaching experience, work experience or other information describing the trainer's credentials.

Both the trainer page and the institution page may be accessible by anonymous users. This may be necessary to aid anonymous users that are searching for knowledge components to make informed purchasing decisions. As was stated earlier, users may not be required to authenticate to the system until they want to enroll in their first knowledge component. A user may search for knowledge components and refer to the institution page and trainer page, prior to making a purchasing decision. Other credentials that indicate the value of the knowledge component and the quality of the trainer may be included in the knowledge exchange system.

The knowledge component page may provide details associated with the knowledge component instance itself, such as recent announcements, reading lists, required textbooks, syllabus, or other knowledge component specific information valuable to the recipients enrolled in the knowledge component. As shown in FIG. 11, the knowledge component pages (Cpage, also known as a “course page” in the e-learning application) may be located under the parent subdirectory represented by 122 and 113. The knowledge component page may be only accessible by recipients that have enrolled in the knowledge component instance and are authenticated to the knowledge exchange system.

Several billing models may be supported by the knowledge commerce system. The knowledge exchange system is a service provided to users, including experts, trainers, institution members, and recipients. The billing models may be dependent on the role of the user, whether they are an individual expert content provider, or an expert member of an institution, whether they are an individual recipient or a recipient member of an institution. The billing models provide incentive for all of the parties to participate in the knowledge commerce system.

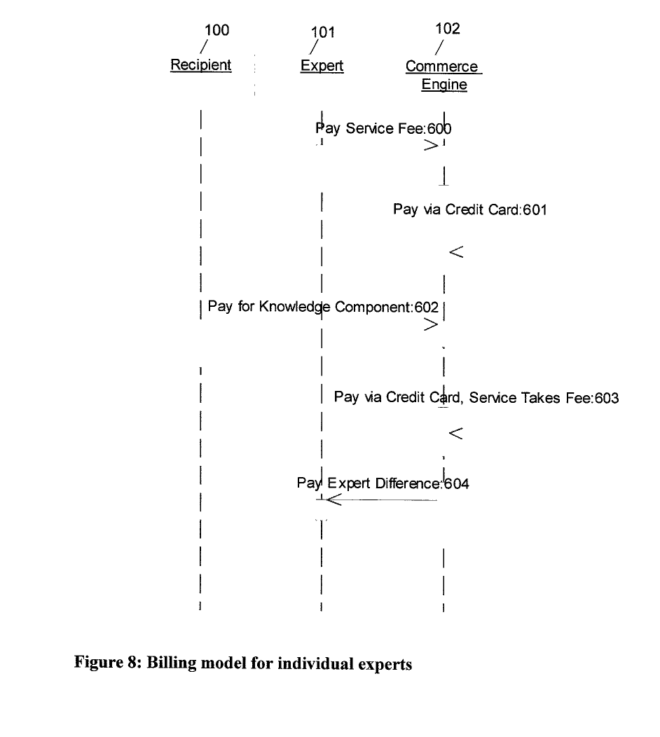

For example, if institutions utilize the knowledge exchange system for knowledge commerce, they may be charged a periodic service fee for such usage. The service charge is paid to the knowledge exchange service provider for providing the knowledge exchange marketplace including delivery of their knowledge components and extending the reach of the institution's knowledge to the entire Internet or like medium for sale. When potential recipients enroll in knowledge components and potentially pay for the knowledge, the recipients pay the knowledge exchange service provider to obtain the knowledge component from the knowledge exchange system, usually via credit card. The knowledge exchange service may then retain a portion of the user's fee as a service fee, and pay the remainder or the revenue collected to the institution or expert that has offered the knowledge component for sale. For example, FIG. 8 illustrates how an individual expert may interact with the knowledge exchange service to offer and deliver their knowledge to the marketplace. In this illustration, it is assumed that the expert is not affiliated with an institution. For example, the individual may be an independent consultant providing expertise for sale in a knowledge area in which he/she is a leading expert. Expert (100) may pay apriori to first use, for access to the knowledge exchange system. The payment interaction to the commerce engine (102) is illustrated in interaction 600. For the purposes of not repeating steps already described (such as authentication of the user), only the billing model related interactions are shown. The commerce engine (102) processes the credit card payment in interaction 601. This may likely include credit card verification and processing with on-line credit card processing companies such as Cybercash. At this point, the expert may contribute his/her knowledge components to the knowledge exchange system and offer them for sale. When a recipient (100) enrolls in a knowledge component offered by the expert, the recipient pays for the delivery of the knowledge component via interaction 602. Again, the commerce engine (102) processes the credit card as shown in interaction 603. The total charge paid by the recipient may be divided into one or more portions. For example, the majority of the payment may be added to the expert's revenue account and be periodically paid-out to the expert, as illustrated in interaction 604. However, a small portion (percentage or fee) of the payment may be collected as a charge by the knowledge service provider as additional compensation for providing the knowledge exchange service and closing the transaction. For example, if the knowledge component is offered by the expert for $1000, the knowledge exchange service provider may collect 5% of the total ($50), and provide the remainder back to the offering expert ($950). The payments made back to the expert may be provided on a periodic basis, such as bi-weekly, monthly, quarterly. The percentage value of the fee charged by the knowledge service provider can range from 0% to 100%. However, as the percentage increases, the motivation of the expert to contribute knowledge components to the knowledge exchange service diminishes. Thus, it is in the best interest of all parties to keep the percentage charge modest.

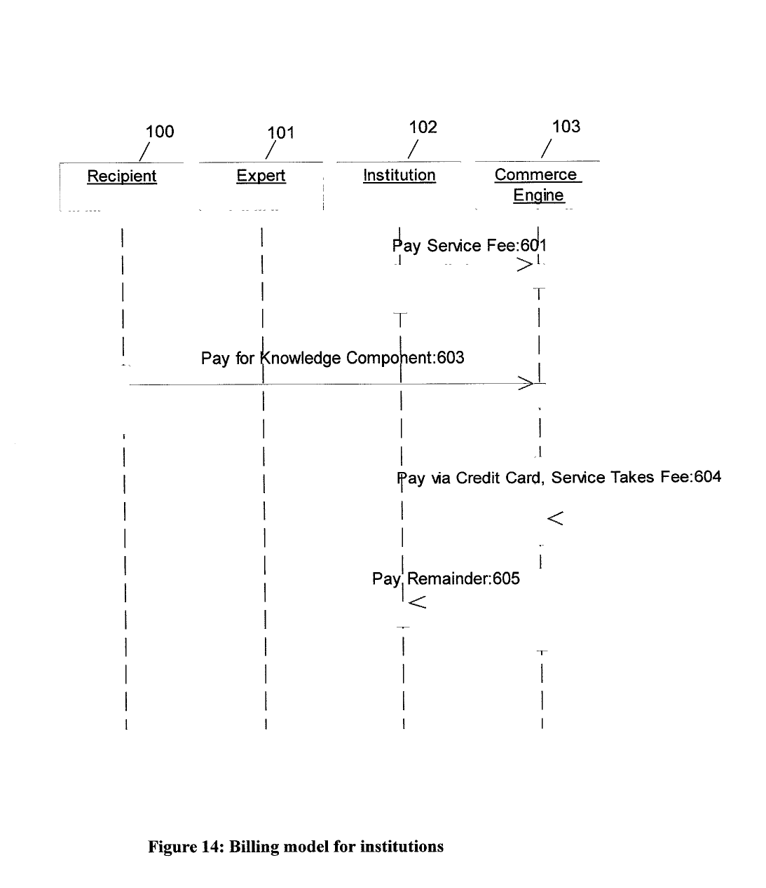

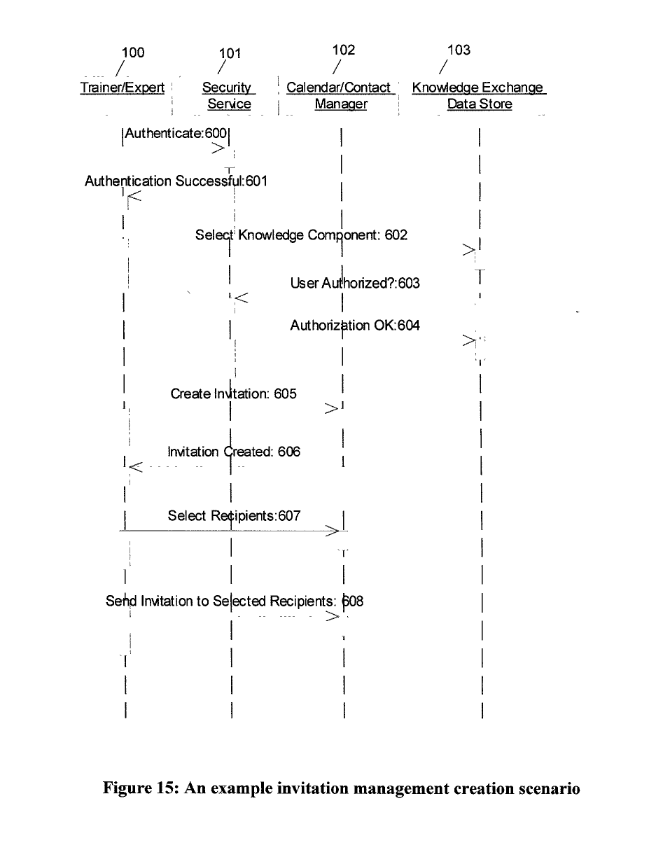

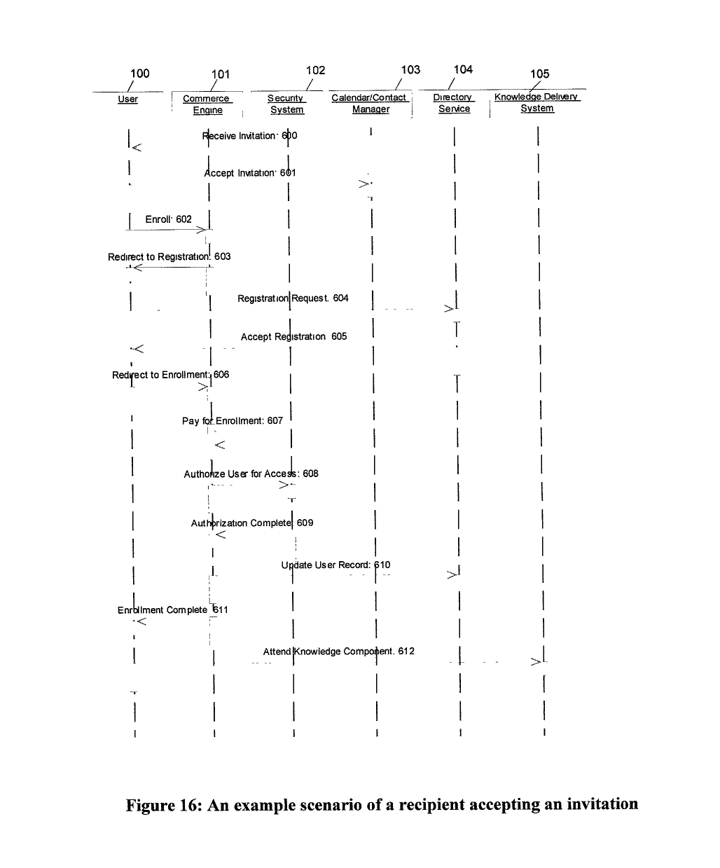

Alternatively, the expert may be a member of an institution that participates in the knowledge exchange system, as illustrated in FIG. 14. The institution (102) may pay the periodic service fee to the institution prior to use of the service, as illustrated in interaction 601. It is assumed in interaction 601 that the payment is made via a purchase order. However, any means of payment may be accepted. At this point, expert members (101) of the institution may contribute their knowledge components to the system. Also, the institution may automatically contribute knowledge components. Recipients (100) may enroll in the knowledge components being offered by the institution and pay for it as shown in interaction 603. The commerce engine (103) processes the credit card payment, and may retain a portion of the total payment as a service charge or transaction fee. The illustration shows payment made by credit card. However, any form of electronic payment mechanism may be acceptable. This statement applies for all payment interactions in the knowledge commerce system. The percentage that is retained by the knowledge exchange service provider may be established by the knowledge exchange service provider. Note that the commerce services may be out-sourced to a third party by the knowledge commerce service provider. Interaction 605 shows that the commerce engine (103) provides back to the institution the remainder of the collected payment made by the recipient of the knowledge component. Payments made to the institutions may be instantaneous or periodic via electronic payment means, or paper based such as cutting a check and mailing it to the institution.

To summarize this billing model, the user pays for the knowledge component via credit card or other like payment mechanism, the knowledge exchange system retains a portion of the payment as a service charge, and the knowledge exchange system provides back to the individual expert or offering institution the remainder of the user's payment. The individual expert or institution may be charged a periodic service fee to use the knowledge exchange service.

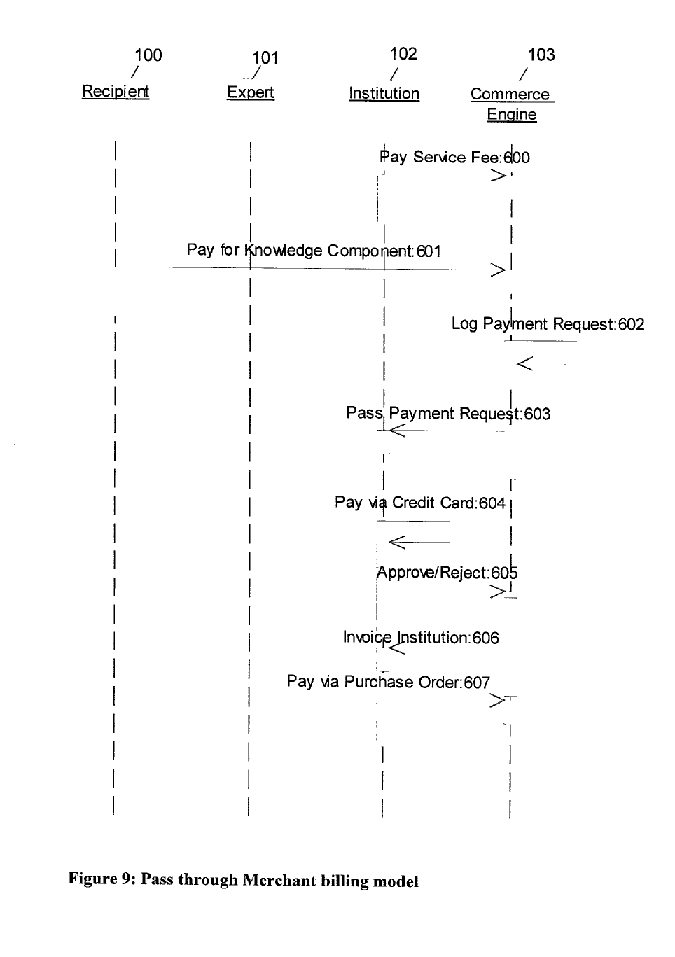

One of the disadvantages of the former billing model is that the knowledge exchange service provider is responsible for the majority of charge-backs made by recipients that pay for the knowledge components via credit card. When a recipient disputes a charge on their credit card, the “merchant of record” is ultimately responsible for the cost. Usually, the disputed charges are never collected by the merchant from the credit card company. Therefore, it is advisable for the knowledge exchange service provider to not be the “merchant of record” for knowledge components being offered by institutions via the knowledge exchange system. FIG. 9 illustrates a “pass through” billing model where the merchant of record for the institution's offered knowledge components is not the knowledge exchange service provider, but is the institution itself. In this model, the institution (102) still pays a service fee prior to first use of the knowledge exchange system via interaction 600. The institutional service fee may be periodic or one time. At this point, the institutional experts (101) may contribute their knowledge components to the knowledge exchange service. Alternatively, the institution may automatically contribute the knowledge components as was previously described in the business-to-business content contribution model.

When a recipient (100) enrolls and pays for a knowledge component as shown in interaction 601, the commerce engine (103) does not process the payment via a credit card processing company, but logs the payment request (interaction 602), and passes the payment request to the offering institution via interaction 603. At that point, the institution, which is the merchant of record for this knowledge component, may process the credit card payment. Assuming the processing is successful, the institution sends an approval message (via interaction 605) to the knowledge exchange commerce engine (103) and the recipient is authorized for the knowledge component. Since the institution collected the revenue from the knowledge component, the knowledge exchange service provider may periodically invoice the institution via interaction 606 to collect the knowledge exchange service provider's percentage of the knowledge component cost. Collections (interaction 607) may be made periodically and may include collections for all knowledge components sold during the collection period. Alternatively, collections may be made immediately for each knowledge component sold. Collections may be carried-out electronically if the institution and knowledge exchange service provider have electronic payment interchange established.

Thus, in this alternative billing model, the offering institution is the merchant of record and not the knowledge exchange service provider. This provides an incentive for the offering institution to maintain high quality standards for their knowledge components, so as to avoid charge backs.

Note that the knowledge exchange service provider may still have to be the merchant of record of individual expert contributors (not institutions), since such individuals will likely not have a financial relationship with credit card processing companies. However, as more individuals establish such relationships, the pass through billing model becomes feasible for individual experts also.

In another variant to the above billing models, an institution may desire to have all of its own institutional members be provided “free” access to the institution's knowledge components. In this case, the knowledge exchange service may not charge the institution's members for access to the institution's knowledge components, but may instead charge the institution directly a higher periodic service charge. Thus, instead of retaining a portion of the recipient's fee, the knowledge exchange service would charge a higher periodic service charge directly to the offering institution. Note that the institution members are not charged only for knowledge components offered by that institution. All other knowledge components (not offered by the institution) would incur enrollment charges. The institution's delegated administrator can enable users to automatically bill all knowledge components to the institution, or to require the user to pay for each course via their credit card. Knowledge components offered by the institution and taken by institutional recipients may be by default provided “free” to all institutional members, but the institution delegated administrator can disable this feature such that all consumers are required to use their credit card, or some other means of payment. If the delegated administrator disables payment by credit card or some other means, for institutional courses, the institution is billed the additional charges for each course taken by the institutional consumers.

In another variant to this model, institutional members may not be charged enrollment fees for any knowledge components or subsets of knowledge components. Instead, the knowledge exchange service provider may bill all enrollment charges directly back to the institution itself, thus not requiring the individual institution members to pay for the knowledge components. Again, the delegated administrator for the institution may be provided this choice of billing model.

An alternative billing model may use a combination of periodic service fees and usage tracking to bill the content provider (expert or institution). The cost of running the knowledge exchange service is mainly a function of whether the course uses streaming audio/video or not. If streaming is used, then the cost of running the service is more specifically a function of the number of recipients, total number of streaming sessions and their duration. Streaming services consume significant communications bandwidth and CPU resources. Thus, knowledge components that require streaming may cost the knowledge exchange service provider more. Thus, those costs may be charged back to the offering expert or institution.

A system of cost accounting is herein described. The additional cost of streaming can be accounted for by accounting for a new unit called the Streaming Session Unit (SSU). An SSU is a unit of resource usage corresponding to streaming, whether it is for live, self-paced or archived knowledge delivery. For example, a trainer may deliver a live knowledge component for 1 hour to 7 recipients, all of who attend for the full duration of the session. The total number of SSUs is 1+7*1=8 SSUs. That is, one SSU for the trainer's stream to the knowledge exchange service, and 7 to delivery the stream to the 7 recipients for one hour. In another example, 18 consumers may take delivery of an archived knowledge component over a billing period. The course has 3 sessions of 2 hours each. The total number of SSUs billed back to the trainer or the trainer's institution would be: 3*2*18=108 SSUs. Since the knowledge component is archived, there is no charge for the trainer's stream because the stream is sourced from the knowledge exchange service and not from a remote trainer's computer.

SSUs may be purchased in advance and depleted from a pool. SSUs may be of different categories. For example, streaming that requires 64 kbps bandwidth may be labeled a type 1 SSU. Streaming that requires 256 kbps, may be labeled a type 2 SSU. Each type of SSU may have a different associated cost per unit.

Institutions and individual experts may pays for ahead of time Streaming Session Units (SSU) for use of streaming services. Alternatively, they may be billed after the knowledge delivery has occurred. Billing may be instantaneous or periodic. The SSU stream costs and the service fees may be combined. For example, the institution may be charged a periodic fee that is the sum of the periodic service fee plus the total number of SSUs utilized during that period for the delivery of the knowledge components offered by the institution. Note that SSU stream tracking billing model may be combined with any of the billing models previously described in this invention. FIG. 13 summarizes an example usage and tracking billing model from the perspective of the various knowledge commerce participants. For example, individual content providers (experts) may be charged a service fee (subscription based) plus the SSU charges. They may be billed via their credit card. The knowledge exchange service may collect a percentage, e.g., 15%, of the cost of the knowledge component as a transaction fee. The individual may offer their knowledge components to the entire Internet.

Institutional content providers and experts may be charged higher service fees and SSU tracking charges. Institutional members may not be directly charged for knowledge components offered by the institution. Alternatively, the knowledge exchange system provider may require a smaller percentage, e.g., 10%, of the knowledge component fee because the institution provides a larger amount of sales, as compared to the individual non-institutional based content provider. The institution may offer their knowledge components to closed groups of users (such as only their institutional members) or the Internet at large.

Individual recipients may not pay a subscription or service fee, but pay on a per enrollment basis. Institutions may pay on a per use basis billed either to the institution or directly to the recipients via their credit card. Institutional members are not necessarily directly billed to enroll in knowledge components offered by the institution. However, the institution is charged a percentage of the knowledge component cost that is offered to non-institutional member. If the knowledge component is offered only to institutional members, then a reasonable cost is negotiated between the institution and knowledge exchange service provider, so that the knowledge exchange service provider can collect a percentage of the cost. There are several applications of the knowledge commerce system including but not limited to the following examples. The knowledge commerce system incorporates incentives to all parties to participate in the system, and thus stimulates the creation of knowledge electronic marketplaces for all kinds of knowledge domains.

The knowledge commerce system may be applied to E-learning or Internet based training applications. Experts and institution may provide knowledge components in the form of slide shows, spread sheets, documents, and may deliver the knowledge contained in those document to the recipients live, archived or self-paced over the Internet. The knowledge delivery system may be utilized to extend the traditional classroom over the Internet while encouraging collaboration. Institutions may use the business-to-business content contribution capabilities of the knowledge exchange system to automatically update the knowledge exchange system of course offerings and their characteristics. E-learning can include home schooling, vocational training, union member training and certification, all levels of education from toddler through graduate degree training, civil service training and examination, adult education, medical certification and license renewal, etc.

Institutions that participate in the E-learning system may, but are not required to use the business-to-business feature of the knowledge commerce system to automatically provide their content to the knowledge exchange system. For example, every semester as courses are offered at a University, the same courses could be offered via the knowledge exchange system. The course listings and characteristics may automatically be contributed to the knowledge exchange system, possibly every semester. Updates or changes to the schedule of courses or characteristics may be automatically modified via the business-to-business capabilities of the knowledge exchange system. This can result in a great increase in efficiency with which courses are offered via the knowledge exchange system. That is, the knowledge exchange service provider (in this case the provider of the E-learning service) would not be required to manually interact with all of the institutions, once the institution has subscribed to the service. The E-learning service provider is thus able to provide services to a very large number of institutions, using a small staff. The service operates with minimal human intervention.

The knowledge exchange system may be applied to enabling seminars or conferences to take place over the Internet. Furthermore, the conferences or seminars may become more collaborative, enabling the recipients to participate in the knowledge delivery. Conference providers are analogous to institutions in the knowledge commerce model. They may subscribe to the knowledge exchange service to place their live presentations on the knowledge exchange service for live and archived presentations. Internet users may enroll in various presentations that are to be offered by the conference via the knowledge exchange system. Internet users pay for enrollment via their credit card.

As the speakers at the conference provide their presentations, typically using Microsoft PowerPoint or other tools, the knowledge delivery system can simultaneously deliver the presentation to Internet users located throughout the world. The Internet users are able to submit questions to the speaker during the presentation, effectively extending the meeting to over the Internet.

The knowledge commerce system may be applied to providing consulting services over the Internet. That is, consultants may provide live, self-paced and archived presentations or collaborative sessions with their clients over the Internet or like medium. In this case, the consulting institution would not want their clients to be charged to participate in the presentations. Thus, the consulting institution would pay a higher service fee and/or utilize the SSU tracking model to pay for their client's usage.

The knowledge commerce system may be applied to product and services sales, marketing and demonstration. Marketing people may demonstrate products over the Internet to remote customers. The users may be prompted to make purchases or ask questions during the presentation. For example, the Home Shopping Network may use this service to provide users with live descriptions of products and the ability to purchase them instantaneously. Users may type questions or ask questions about the products via streaming audio. A software company may demonstrate their software to remote clients over the Internet using the remote program demonstration feature, for example. Furthermore, the software company may train clients on the use of their software over the Internet. In this case, the software company may act as the institution, and the clients would act as recipients. Again, recipients would not necessarily be prompted to pay for attending the product demonstration and presentation. The offering institution would likely be charged by the knowledge exchange service provider.

The knowledge commerce system may be applied to Internet based kiosk. A web site developer that manages a travel agency web site may desire to show potential clients multimedia presentations of various vacation destinations. For example, the web site may list information on Bermuda and if a use wants to view a presentation about Bermuda, the user would click on a button. This would case the presentation to be executed from the knowledge exchange service provider's facilities (unbeknownst to the user), and an archived presentation of Bermuda would be played for the user. The user is able to see and hear information about Bermuda in a multimedia presentation and can thus make a more informed vacation purchasing decision. The travel web site would play the institution role in the knowledge commerce system. They would pay a service charge to the knowledge exchange service provider and again, their web site users would not be forced to enroll in the presentation or be charged to watch the presentation. The travel agency providing the travel web site would out-source the delivery of the presentations to the knowledge exchange service provider. Thus, the travel agency web site would not have to have the skill to develop a multimedia, collaborative delivery infrastructure as is already provided by the knowledge exchange service provider. The users of the travel web site would think they have not left the web site during the presentations. In this model, the users or recipients may not be required to register with the knowledge commerce system. This would allow the institution, or travel web site in this example, to not inconvenience the travel web site users with the task of registration. However, if registration is not required of the institutional user (travel web site users), then the knowledge component may be maintained in a publicly readable area of the knowledge exchange system (public data store). The institutional authors and delegated administrator would still be required to register with the knowledge commerce system to be authenticated and authorized to change the knowledge component, but recipients would not necessarily be required to register with the knowledge commerce service provider to view the knowledge component. The knowledge exchange service provider may co-brand the presentation.

In another application of the knowledge commerce system, Internet live multimedia based presentations and collaborations may be provided by web sites, without the web site developers having to implement the delivery infrastructure. This application of the invention is similar to the kiosk application, but instead of providing only archived presentations, live presentations and collaboration may be provided. Again, taking the travel web site as an example, the travel agency may want to provide to their web site customers live presentations about or from various travel destinations. Thus, the travel agency may utilize the knowledge exchange service to carry-out live presentations or collaborations from various travel destinations. The web site customers may see advertised on the travel agency's web site that there will be a live collaborative presentation on Bermuda scheduled at certain dates and times. Customer may “tune in” to participate in the live collaborative presentations. Users may ask the presenter questions about the destination, etc. The presentations may be given from the travel destinations or from anywhere over the Internet. The collaborative presentations may be a combination of live presenters and archived presentations interleaved with the live presentations. For example, the presenter may inter-mix streaming video presentations of various aspects of Bermuda with the live presentation.

The travel agency may essentially out-source the delivery of these collaborative presentations to the knowledge exchange service provider. The web site developer of the travel site may simply insert some reference scripting code onto their web pages. This code would list the presentations, schedule of delivery, topics, etc. for the benefit of the users of the travel agency's web site. The knowledge exchange service provider may provide the code. Just as in the kiosk case, the travel agency would be charged a service fee to provide such live presentations. The travel agency may be charged via any of the billing models included in this invention, including charging for streaming units (SSU). The travel web site users would not be charged to participate in the collaborative presentations. They may, however, be required to register with the knowledge exchange service provider. Registration may, but is not required to be carried-out within a sub window or frame of the travel agencies web site, so that the users do not know they have left the travel agencies web site to register for the presentation. Alternatively, the travel agency may, but is not required to automatically provide the registration information to the knowledge exchange service provider in an electronic interchange. This would not require the user to re-register at the knowledge exchange service, because the current web site registration information would be migrated to the knowledge exchange service provider's site. Separate interactions would need to be established to keep the registration information up-to-date.

Alternatively, the knowledge components may be stored in a publicly readable area within the knowledge commerce system such that user registration to view the knowledge component is not required, but is required for creating, editing, deleting, contributing knowledge components. In this alternative application, the travel web site author may create knowledge components about travel destinations, and contribute them to the knowledge commerce system, indicating that they are to be placed in the publicly accessible area in the knowledge commerce system. The knowledge commerce system may provide a mechanism to create a URL that references the particular knowledge commerce component. The URL may be provided back to the institutional author for inclusion and reference from the institutions web site.

In the example of a travel site, the travel site author may create a self-paced presentation about Bermuda and contribute it to the knowledge commerce system, indicating that it be publicly viewable. The knowledge commerce system may but is not limited to providing a facility for the author that provides a reference URL for accessing the knowledge component. The travel site author may but is not limited to including the URL on their own travel site, indicating to their users that should they click on the URL, they would see a presentation about Bermuda, for example. The travel site users would be provided with a presentation on Bermuda from the knowledge commerce service infrastructure, but would not be required to register or take any actions prior to viewing the presentation. The presentation may be completely branded by the institution, or co-branded by both the institution and the knowledge commerce service provider.

In another application of this invention, live collaborative web casts may be provided for various situations or events. Typically, web casts are produced that allow a presenter or multiple presenters to provide a streaming audio and or video presentation to a potentially large audience. A collaborative web cast is one where the recipients can interact with the presenters during and after the web cast. For example, a politician may desire to provide a live “town-meeting” over the Internet. The politician may provide answers to questions from the audience that is in the room where he/she is located, as well as from the Internet audience. Internet audience users hear the presentation, interact with the politician by asking questions and participating in the discussion either via text interactions or by asking audio questions. The politician may have a support staff of experts that may receive questions from the audience during the collaborative web cast so that no one expert is overwhelmed with questions from the potentially large audience.

In another application of the invention, streaming Internet radio may be delivered to Internet users in synchronization with corresponding streaming videos of the music performances. Additionally, other presentation materials (advertisements, band photographs, animations) may simultaneously be sent to the recipients during the playing of streaming radio and/or video. Simultaneously, radio listeners and watchers over the Internet may collaborate with the radio personalities or performers as the shows are broadcast.

The system described above includes a variety of embodiments. Other embodiments are considered within the scope of the invention. The invention is known through the following claims.

We claim:

1. An electronic knowledge commerce system comprising a knowledge exchange system, a knowledge recipient, a knowledge expert, a communication medium, wherein said knowledge exchange system comprises one or more data stores containing knowledge components and their characteristics, a commerce engine, a knowledge delivery system, and a security system.

2. The system according to claim 1 where said knowledge exchange is delivered over the world wide web.

3. The system according to claim 2 wherein said knowledge exchange is delivered live.

4. The system according to claim 2 wherein said knowledge exchange delivers archived knowledge generated from a live knowledge exchange.

5. The system according to claim 3 wherein the system includes one or more of page flip, interactive question and answer, telephone based audio, streaming based audio, streaming based video, discussion groups, chat, white board, remote program demonstration, polling service, group membership based applications, annotation service, follow-me browsing, voice over IP services and examination services.

6. The system according to claim 4 wherein the system includes one or more of page flip, interactive question and answer, telephone based audio, streaming based audio, streaming based video, discussion groups, chat, white board, remote program demonstration, polling service, group membership based applications, annotation service, follow-me browsing, voice over IP services and examination services.

7. The system according to claim 3 further comprising collaboration services wherein said collaboration services are provided without requiring plug-ins, installed programs, controls such as Java Applets, ActiveX controls at a user's browser, and wherein the collaboration services operate through a security filtering system.

8. The system according to claim 4 further comprising collaboration services wherein said collaboration services are provided without requiring plug-ins, installed programs, controls such as Java Applets, ActiveX controls at a user's browser, and wherein the collaboration services operate through a security filtering system.

9. The system according to claim 2 wherein an institution contributes knowledge components in an automated business-to-business process.

10. The system according to claim 2 wherein an institution is provided with delegated administration capabilities by said knowledge commerce system.

11. The system according to claim 2 wherein said knowledge exchange system includes an invitation management system.

12. The system according to claim 3 wherein a knowledge expert that authenticates to the knowledge exchange system, contributes one or more knowledge components to the knowledge commerce system and establishes characteristics for the knowledge components.

13. The system according to claim 2 wherein the commerce engine may provide pay-per-unit commerce capabilities, wherein a billing unit includes a streaming session unit, a telephone session unit, a duration of access unit, or a collaboration service or combinations thereof.

14. The system according to claim 13 wherein said collaboration service comprises one or more of page flip, chat, discussion group, annotation service, interactive question and answer, white board, remote program demonstration, polling service, group membership based applications, follow me browsing, voice-over-IP services, and examination services.

15. The system in claim 13 wherein a knowledge commerce system provider may act as the merchant of record for a purchase of a knowledge component.

16. The system in claim 13 wherein said institution may act as the merchant of record for a purchase of a knowledge component.

17. An application of the system according to claim 2 for providing e-learning.

18. An application of the system according to claim 2 for providing remote seminars.

19. An application of the system according to claim 2 for providing remote consulting.

20. An application of the system according to claim 2 for providing product marketing and sales.

21. An application of the system according to claim 2 for providing collaborative web casting.

22. An application of the system according to claim 2 for providing kiosk based presentations.

23. The system according to claim 22 wherein a user at a first web site may access a knowledge component in a publicly readable area of said knowledge exchange system to access said knowledge component such that user registration and or authentication is not required by said knowledge exchange system in order for said user to receive said knowledge component.

24. A knowledge commerce system comprising a knowledge exchange system, a knowledge recipient, a knowledge expert, and a communication medium, wherein said knowledge exchange system comprises one or more data stores containing knowledge components and their characteristics, a commerce engine, a knowledge delivery system, and a security system and wherein a knowledge expert may contribute knowledge components to said knowledge exchange system and wherein knowledge expert may deliver said knowledge components live over the world wide web to one or more knowledge recipients.

25. The system according to claim 24 further comprising collaboration services which comprise one or more of page flip, chat, discussion group, annotation service, interactive question and answer, white board, remote program demonstration, polling service, group membership based applications, follow me browsing, voice-over-IP services, and examination services, within the knowledge delivery system are provided to a user's browser without requiring said user to install additional software, plug-ins or automatically down loadable compiled control components, and wherein said collaboration services operate through security filtering systems.

26. The system according to claim 25 wherein said collaboration services operate through security filtering systems using http type protocols comprising http, httpdav through port 80 or the https protocol through port 443.

27. A knowledge commerce system comprising of one or more knowledge experts, one or more knowledge recipients, a knowledge exchange service provider, and a communication medium wherein said knowledge expert may interact with said knowledge exchange service provider in a self-service manner wherein said knowledge expert may contribute knowledge component to said knowledge exchange service provider and use collaboration services provided by said knowledge exchange service provider to deliver said knowledge component live over the world wide web to said knowledge recipients, and where said knowledge recipients pay said knowledge exchange service provider an enrollment fee to receive said knowledge component and wherein said knowledge exchange service provider provides all or some part of said knowledge recipient's said paid fee to said knowledge expert.

28. The system according to claim 24 where said knowledge exchange is delivered through security filtering systems.

29. The system according to claim 1 where said knowledge exchange is delivered over a private network.
